(19) United States
(12) Patent Application Publication
(10) Pub. No.: US 2024/0408497 A1
(43) Pub. Date: Dec. 12, 2024

(54) GAME SYSTEM, STORAGE MEDIUM USED THEREIN, AND CONTROL METHOD

(71) Applicant: KONAMI DIGITAL ENTERTAINMENT CO., LTD., Tokyo (JP)

(72) Inventors: Shigeru CHIBA, Tokyo (JP); Akira SAKAI, Tokyo (JP); Yoshihiko NARITA, Tokyo (JP)

(73) Assignee: KONAMI DIGITAL ENTERTAINMENT CO., LTD., Tokyo (JP)

(21) Appl. No.: 18/809,781

(22) Filed: Aug. 20, 2024

Related U.S. Application Data
(63) Continuation of application No. PCT/JP2023/004767, filed on Feb. 13, 2023.

(30) Foreign Application Priority Data
Mar. 17, 2022 (JP) 2022-042864

(51) Int. Cl. A63F 13/61; A63F 13/63; G06Q 30/0251

(52) U.S. Cl. CPC A63F 13/61; A63F 13/63; G06Q 30/0269

(57) ABSTRACT

The present invention provides a game system that can utilize a game screen generated through play by each player as an advertisement material. A game machine (game system) is connected via a network to an advertisement distribution system that distributes an advertisement to a plurality of advertisement display devices and provides each player with a game that progresses on a series of game screens according to a play situation generated according to a play action of each player. Moreover, the game machine discriminates a specific game screen that satisfies an advertisement condition from among the series of game screens in the play of each player, generates display data for displaying the specific game screen, and transmits the generated display data to the advertisement delivery system so that a game advertisement including the specific game screen as the advertisement material is distributed as the advertisement.

### BACKGROUND OF THE INVENTION

### Field of the Invention

The present invention relates to a game system that is connected via a network to an advertisement distribution system that distributes an advertisement to at least one advertisement display device that displays the advertisement to a plurality of users, and provides each player with a game that progresses on a series of game screens through an input device that inputs a play action of each player and a display device that displays the series of game screens according to a play situation generated according to the play action.

### Description of the Related Art

There is a game system that is connected via a network to an advertisement distribution system that distributes an advertisement to at least one advertisement display device that displays the advertisement to a plurality of users, and provides each player with a game that progresses on a series of game screens through an input device that inputs a play action of each player and a display device that displays the series of game screens according to a play situation generated according to the play action. For example, a system using a terminal device used by each user as such an advertisement display device is known (see, for example, Patent Literature 1).

### CITATION LIST

### Patent Literature

Patent Literature 1: JP6464278B

### SUMMARY OF THE INVENTION

### Technical Problem

In advertising a game, an actual game screen is often used to convey its attraction. To prepare such a game screen, it is necessary to actually play the game until a desired game screen (play situation) occurs or to create the desired game screen. For this reason, it tends to take time and effort to prepare an advertisement material. As a result, there are possibilities that an old game screen is continuously used, or a game screen corresponding to the best scene (play situation) is not prepared.

Meanwhile, players often play with the latest game screen, and often naturally generate a more attractive game screen as the advertisement material in the play. In the first place, there is a possibility that players know in detail what kind of game screen is attractive as the advertisement material. Therefore, if the game screens generated in the play by the players can be used as the advertisement materials, not only the time and effort can be reduced, but also collection of various game screens such as the latest game screens, game screens that are hardly seen, and attractive game screens can be expected.

Further, the needs of players are variously changing, and each player may have a need not only to simply enjoy playing but also to share a favorite game with other users, contribute to the game in some form, or connect the play of the game to some revenue. If the game screens generated in the play by the players can be used as the advertisement materials, it is possible to meet the needs of the players such as a desire for contribution. Furthermore, by meeting the needs of the players, it is possible to expect promotion of collection of various game screens.

In the system of Patent Literature 1, an advertisement including an image stored in a memory of a terminal device is displayed on a display of the terminal device in addition to a browser image during execution of a browser application. An image corresponding to a game screen may be used as the image included in the advertisement. However, in the system, the image of the game played by the user is merely displayed as an advertisement on the user's own terminal device, and the advertisement is not distributed to a plurality of users including other users other than the user. That is, the use of the image of the game played by each user is limited to the advertisement for the user. Therefore, in the system of Patent Literature 1, the image of the game cannot be sufficiently utilized as the advertisement material. In addition, it is not possible to meet the user's needs such as a desire for contribution. As a result, there is also a high possibility that the collection is not promoted by the users, not leading to the collection of various images such as images that are hardly seen or more attractive images.

Therefore, an object of the present invention is to provide a game system and the like that can utilize a game screen generated by play of each player as an advertisement material.

### Solution to Problem

A game system of the present invention is a game system comprising a computer that is connected via a network to an advertisement distribution system that distributes an advertisement to at least one advertisement display device that displays the advertisement to a plurality of users, and provides each player with a game that progresses on a series of game screens through an input device that inputs a play action of each player and a display device that displays the series of game screens according to a play situation generated according to the play action, wherein the computer serves as: a screen discrimination unit that discriminates a specific game screen that satisfies a predetermined condition among the series of game screens displayed on the display device in play by each player of the game; a data generation unit that generates display data for displaying the specific game screen; and a data transmission unit that transmits the display data to the advertisement distribution system such that a game advertisement including the specific game screen as an advertisement material is distributed as the advertisement to the plurality of users via the advertisement display device.

A non-transitory computer readable storage medium of the present invention is a non-transitory computer readable storage medium storing a computer program configured to cause a computer connected to the advertisement distribution system, the input device, and the display device to function as each unit of the game system.

A control method according to the present invention is a control method executed by a computer incorporated in a game system that is connected via a network to an advertisement distribution system that distributes an advertisement to at least one advertisement display device that displays the advertisement to a plurality of users, and provides each player with a game that progresses on a series of game screens through an input device that inputs a play action of each player and a display device that displays the series of game screens according to a play situation generated according to the play action, wherein the control method comprises: a screen discrimination procedure of discriminating a specific game screen that satisfies a predetermined condition among the series of game screens displayed on the display device in play by each player of the game; a data generation procedure of generating display data for displaying the specific game screen; and a data transmission procedure of transmitting the display data to the advertisement distribution system such that a game advertisement including the specific game screen as an advertisement material is distributed as the advertisement to the plurality of users via the advertisement display device. By executing the computer program or the control method of the present invention, the game system of the present invention can be implemented.

### BRIEF DESCRIPTION OF THE DRAWINGS

FIG. 1 is a figure illustrating an example of an overall configuration of a network system according to an embodiment of the present invention.

FIG. 2 is a figure illustrating an outline of a system constructed in a network system.

FIG. 3 is an explanatory figure for describing an example of a schematic procedure of a game advertisement service.

FIG. 4 is an explanatory figure for describing a method of discriminating an advertisement material.

FIG. 5 is an explanatory figure for describing an example of content of condition data.

FIG. 6 is a figure schematically illustrating an example of a solicitation advertisement screen.

FIG. 7 is an explanatory figure for describing an example of a reward associated with provision of an advertisement material.

FIG. 8 is a figure schematically illustrating an example of a game screen when an advertisement material is discriminated by a player designation type.

FIG. 9 is an explanatory figure for describing generation of a game advertisement according to a first method.

FIG. 10 is an explanatory figure for describing generation of a game advertisement according to a second method.

FIG. 11 is a figure schematically illustrating an example of an edit screen.

FIG. 12 is a functional block figure illustrating an example of a main part of a control system in a server.

FIG. 13 is a functional block figure illustrating an example of main parts of control systems in an advertisement display device and a game machine.

FIG. 14 is a figure illustrating an example of a configuration of condition data.

FIG. 15 is a figure illustrating an example of a configuration of screen data.

FIG. 16 is a figure illustrating an example of a configuration of form data.

FIG. 17 is a figure illustrating an example of a configuration of notification destination data.

FIG. 18 is a flowchart illustrating an example of a procedure of first material collection processing.

FIG. 19 is a flowchart illustrating an example of a procedure of second material collection processing.

FIG. 20 is a flowchart illustrating an example of a procedure of solicitation information acquisition processing.

FIG. 21 is a flowchart illustrating an example of a procedure of screen information acquisition processing.

FIG. 22 is a flowchart illustrating an example of a procedure of a game advertisement generation processing.

FIG. 23 is a flowchart illustrating an example of a procedure of initial reward provision processing.

FIG. 24 is a flowchart illustrating an example of a procedure of additional reward provision processing.

### DESCRIPTION OF THE EMBODIMENTS

### (Overall Configuration)

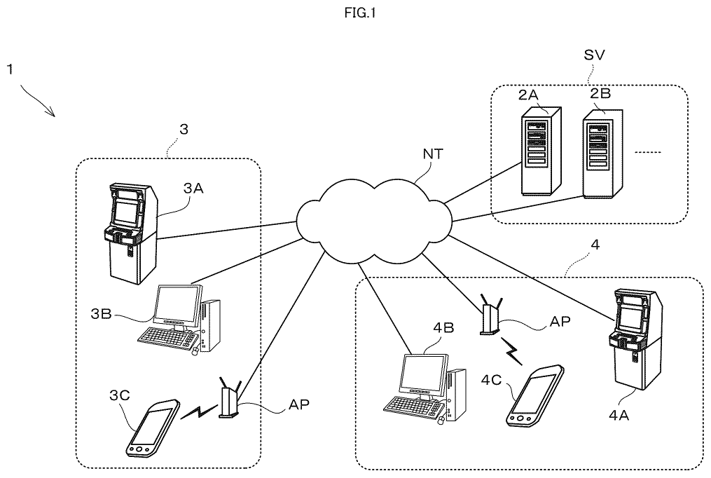

Hereinafter, one embodiment of a game system and an advertisement distribution system of the present invention will be described. The game system and the advertisement distribution system of the present embodiment are configured as a part of a network system that provides a predetermined service to a user. The predetermined service includes a game advertisement service. The game advertisement service is a service implemented by a combination of the game system for providing a game and the advertisement distribution system for distributing an advertisement. Hereinafter, first, an outline of the network system will be described, and then, configurations of the game system and the advertisement distribution system will be described. As illustrated in FIG. 1, a network system 1 includes a server SV. A game machine 3 and an advertisement display device 4 are connected to the server SV via a network NT.

As an example, the server SV is configured as a logical server system in which a plurality of server units 2A, 2B, and the like (hereinafter may be represented by reference numeral 2) are combined. The server units 2 may be collectively installed at specific positions on the network NT, or may be installed in a distributed manner on the network NT using cloud computing so as to configure a so-called cloud type server system. The network NT may be appropriately configured as long as the game machine 3 and the advertisement display device 4 can be communicably connected to the server SV. As an example, the network NT may include the Internet as a WAN, and various connection facilities or devices such as a LAN or an access point AP that connects the server SV, the game machine 3, and the advertisement display device 4 to the Internet.

The game machine 3 is a game device that provides a game to the user. Although the game system of the present invention can be appropriately configured in the network system 1, a case where the game system is configured as the game machine 3, that is, a case where the game machine 3 functions as the game system will be described below. Although the game machine 3 may include various game devices (computer devices) that provide games, an arcade game machine 3A, a personal computer 3B, and a mobile terminal device 3C are illustrated in the example of FIG. 1.

The arcade game machine 3A is a commercial (business) game machine (device) that is installed in a facility such as an amusement store and causes the user to play a game in exchange for collection (consumption) of a predetermined consideration. Each of the personal computer 3B and the mobile terminal device 3C is an example of a computer device that can be connected to a network and is used (individually used) for personal use of the user. The mobile terminal device 3C may include various computer devices such as a mobile phone and a personal digital assistant (for example, a tablet terminal, a portable personal computer, and the like). The example of FIG. 1 illustrates a smartphone as the mobile terminal device 3C. This type of computer device is generally referred to as a user terminal device. The user terminal device provides various services with execution of software (application), and such services include games. That is, the user terminal device such as the personal computer 3B functions as a game device for playing a game with execution of a predetermined application. Further, the application provided in the user terminal device may include an application for displaying an advertisement, and the user terminal device may function as the advertisement display device 4 with the execution of the application.

Incidentally, the various applications may be provided to the user terminal device as appropriate, and may be provided from the server SV via the network NT or may be provided via a storage medium or the like, for example. Further, the present invention is not limited to the personal computer 3B and the like, and various user terminal devices may be used as the game machine 3. For example, various computer devices that can be connected to a network and are used for personal use of users, such as a stationary home game machine and a portable game machine, may be used as the game machine 3. Furthermore, the game machine 3 is not limited to a form including a plurality of types of game devices such as the arcade game machine 3A, the personal computer 3B, and a mobile terminal device 4C, and may be configured by, for example, only one type of game device.

The advertisement display device 4 is a device that displays an advertisement distributed via the advertisement distribution system. As the advertisement display device 4, an appropriate device capable of displaying an advertisement may be used, and for example, one display device installed in a public place as seen by a plurality of users may be used. In the example of FIG. 1, various computer devices capable of network connection are used. Further, such computer devices can appropriately include various computer devices. In the example of FIG. 1, the computer devices include an arcade game machine 4A, a personal computer 4B, and the mobile terminal device 4C.

The arcade game machine 4A, the personal computer 4B, and the mobile terminal device 4C are devices similar to the arcade game machine 3A, the personal computer 3B, and the mobile terminal device 3C described above. The same type of devices may be used as the game machine 3 and the advertisement display device 4, or different types of devices may be used. Furthermore, for example, one user terminal device may function as both the game machine 3 and the advertisement display device 4. Hereinafter, a case where the same one mobile terminal device functions as both the game machine 3 and the advertisement display device 4 will be described as a representative of the user terminal device. However, the user terminal device is described as both the mobile terminal device 3C (hereinafter may be referred to as a mobile game machine 3C) when functioning as the game machine 3 and the mobile terminal device 4C (hereinafter may be referred to as a mobile advertisement device 4C) when functioning as the advertisement display device 4 to distinguish the functions from each other. Further, an appropriate number of mobile game machines 3C and an appropriate number of mobile advertisement devices 4C can be connected to the network system 1 as such user terminal devices.

### (System Constructed in Network System)

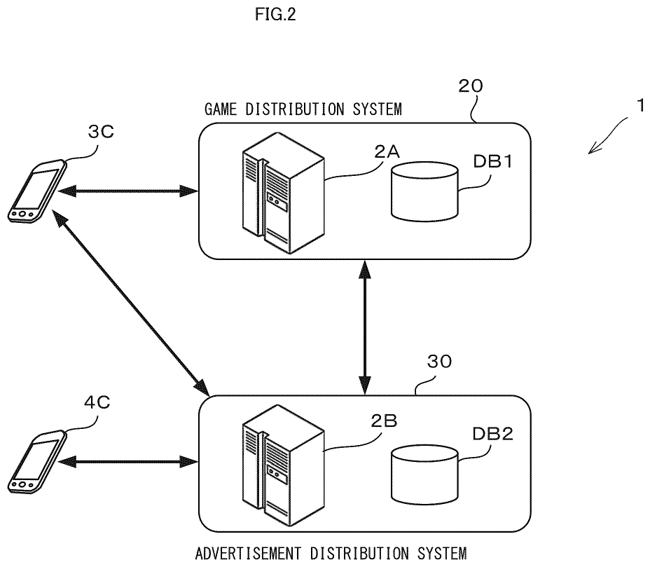

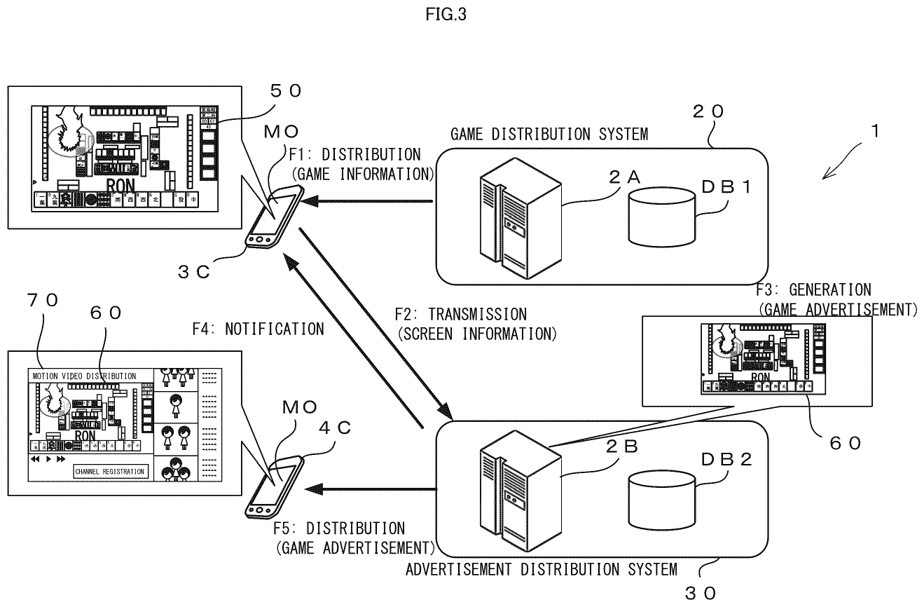

Next, a system constructed in the network system 1 to implement the game advertisement service will be described with reference to FIG. 2. FIG. 2 is a figure illustrating an outline of the system constructed in the network system 1. The game advertisement service is a service for distributing a game advertisement as an advertisement including a game screen of a game provided by the mobile game machine 3C (game machine 3) to the mobile advertisement device 4C (advertisement display device 4). As illustrated in FIG. 3, a game distribution system 20 and an advertisement distribution system 30 are constructed on the server SV of the network system 1 in order to implement the game advertisement service. These systems 20 and 30 are systems implemented by appropriately using the server unit 2A or the like included in the server SV.

The game distribution system 20 is constructed as a system that provides a game-related service using, for example, the server unit 2A and a game database DB1 (for example, one of the server units 2). The game-related service is a service related to a game provided by the mobile game machine 3C. The game-related service may include various services related to a game, and includes, for example, a service for distributing a game screen when the game screen is drawn by the game distribution system 20, but includes, as an example, an information distribution service for acquiring and distributing various types of game information (for example, operation information of the mobile game machine 3C corresponding to each of a plurality of users, and the like when the plurality of users plays a game together via the network NT) necessary for drawing the game screen so that the game screen is drawn by the mobile game machine 3C.

Incidentally, the game-related service may include, for example, a matching service for matching a plurality of users (including both collaborators and opponents) when the plurality of users plays a game together. Similarly, the game-related service may include a distribution service that distributes and updates a program or data of the mobile game machine 3C via the network NT, a service that receives identification information of the user from the mobile game machine 3C and authenticates the user, and a service that receives and stores play data of the authenticated user from the mobile game machine 3C or provides the play data to be stored to the mobile game machine 3C. Furthermore, the game machine service may appropriately include a charging service or the like that collects a fee from the user of the mobile game machine 3C.

Meanwhile, the advertisement distribution system 30 is constructed as a system that provides an advertisement distribution service using, for example, the server unit 2B and an advertisement database DB2 (for example, one of the server units 2). The advertisement distribution service is a service for distributing an advertisement to the mobile advertisement device 4C. The advertisement distribution system 30 may provide the advertisement distribution service such that the advertisement is distributed independently, but provides the advertisement distribution service such that the advertisement is incorporated in a part of another service as an example. Further, various services may be appropriately used as such another service, and for example, a motion video distribution service that distributes a motion video to the mobile advertisement device 4C is used. That is, the advertisement distribution system 30 provides the advertisement distribution service such that the advertisement is incorporated in a part of the motion video distributed by the motion video distribution service, such as at the beginning, at the end, or in the middle as appropriate. Such a motion video distribution service may be provided by an appropriate system (including a single device such as a server device) such as another system constructed in the network system 1 or another system constructed outside the network system 1, but is provided by the advertisement distribution system 30 as an example. That is, the advertisement distribution service is provided as a part of the motion video distribution service.

The advertisement provided through the advertisement distribution service (inserted into the motion video distributed through the motion video distribution service) includes a game advertisement. Then, the advertisement distribution service when such a game advertisement is distributed functions as a part of the game advertisement service. Such a game advertisement may be generated by an appropriate system, for example, may be generated by the mobile game machine 3C or may be generated by the game distribution system 20, but is generated by the advertisement distribution system 30 as an example. Further, the game screen included in the game advertisement may be indirectly provided through (via) the game distribution system 20, but is directly provided from the mobile game machine 3C in the example of FIG. 2. In this case, the advertisement distribution system 30 is connected to the mobile game machine 3C, and provides the game advertisement service (advertisement distribution service) in cooperation with the mobile game machine 3C.

The game distribution system 20 and the advertisement distribution system 30 may be operated by a same operator, but are operated by different operators as an example. In this case, the advertisement distribution system 30 may distribute the game advertisement to the mobile advertisement device 4C for free, but distributes the game advertisement on a chargeable basis as an example. Further, a distribution cost of the game advertisement may be uniformly fixed, but is set as a pay-as-you-go system as an example. That is, the distribution cost is set so as to increase as the number of distributions to the mobile advertisement device 4C increases. Such a distribution cost may be borne by the user (hereinafter may be referred to as a viewer) of the mobile advertisement device 4C, but is borne by the operator of the game distribution system 20 as an example. The game distribution system 20 and the advertisement distribution system 30 may not be connected to each other when transmission and reception of information is unnecessary (for example, when the operators are the same). However, as an example, the systems are connected to each other, and transmission and reception of information necessary for settlement of various costs such as the number of distributions and distribution costs are executed between the systems. Various systems can be appropriately constructed in the network system 1. However, as an example, the game distribution system 20 and the advertisement distribution system 30 are constructed in order to implement the game advertisement service.

### (Outline of Game Advertisement Service)

Next, an outline of the game advertisement service will be described with reference to FIG. 3. FIG. 3 is an explanatory figure for describing an example of a schematic procedure of the game advertisement service. As illustrated in FIG. 3, the game advertisement service includes five procedures F1 to F5. Specifically, the game distribution system 20 distributes game information in response to a request from the mobile game machine 3C (F1). The game information is information necessary for game play such as progress of a game and drawing of a game screen. Such information includes, for example, information such as a past record (play data and the like), operation information and object information of another mobile game machine 3C when a common game is played among a plurality of the mobile game machines 3C.

When acquiring the game information from the game distribution system 20, the mobile game machine 3C displays a game screen 50 based on the game information on a monitor MO, and provides the game via the game screen 50. The mobile game machine 3C may appropriately provide various games such as an action game, a role playing game, a simulation game, and sports games (including both a case of being provided as an action game and a case of being provided as a simulation game) such as a baseball game, but provides a mahjong game in the example of FIG. 3.

The mahjong game is provided through a predetermined application (hereinafter may be referred to as a game application) in the mobile game machine 3C. Such a game application may be implemented as appropriate, but is implemented by using a technology of a software development kit (SDK), for example. Through such a game application, a series of game screens is displayed on the mobile game machine 3C according to a play situation generated according to a play action of the user (hereinafter may be referred to as a player) playing the game. For example, when the mobile game machine 3C provides the mahjong game, various roles (hands) such as Thirteen Orphans and Four concealed Triples are formed through the play actions (such as drawing and discarding tile) of the player in the mahjong game, and the monitor MO displays a series of the game screens 50 each indicating a state in which the role is formed and a play situation up to the role.

Further, when a specific game screen 50 (including both a motion video and a still image) that satisfies a predetermined advertisement condition for specifying an advertisement material is generated as a part of the series of game screens 50, the mobile game machine 3C discriminates the specific game screen 50 and generates screen information for displaying the specific game screen 50 as the advertisement material. Then, the mobile game machine 3C transmits the screen information to the advertisement distribution system 30 (F2). Therefore, the game application is provided with functions to discriminate the specific game screen 50 from the series of game screens 50, to generate the screen information corresponding to the specific game screen 50, and to transmit the screen information to the advertisement distribution system 30.

The screen information can appropriately include various types of information regarding the specific game screen 50, and includes, for example, display data, provider information, type information, play situation information, subject information, evaluation value information, and notification destination information. The display data is data for displaying the specific game screen 50. Various types of data capable of displaying the specific game screen 50 may function as the display data as appropriate, and for example, so-called replay data including the operation information of the player for reaching the specific game screen 50 may function. As an example, motion video data (corresponding to image data when the specific game screen 50 is a still image) functions. Such display data may be configured to display the specific game screen 50 as it is, but is configured to display the game screen 50 to which editing is partially applied as an example. Specifically, the display data is configured to display the game screen 50 in which a portion regarding privacy of the opponent such as a name of the opponent in a battle type game is masked (including both erasure and fill). Such editing may be manually executed by the player, but is automatically executed by the game application as an example. That is, the game application generates the display data while editing the specific game screen 50 such that the game screen 50 including such masking editing is displayed as the specific game screen 50.

The provider is information indicating the player (hereinafter may be referred to as a provider) who has provided the specific game screen 50 (advertisement material). Various types of information capable of identifying each provider may be used as the provider information. For example, when the game distribution system 20 issues a player ID for identifying each player, the player ID may be used, but a viewer ID is used as an example. The viewer ID is an ID uniquely issued by the advertisement distribution system 30 in a system different from the player ID in order to identify each viewer who uses the motion video distribution service. Therefore, the game application also provides an input opportunity for inputting information of the viewer ID. Further, when the provider does not have the viewer ID, the game application also has a function to cooperate with the advertisement distribution system 30 so that the viewer ID is newly issued via the advertisement distribution system 30.

Incidentally, the advertisement distribution system 30 may provide a platform service including a plurality of services such as distribution of various applications, shopping, and e-mail, and the motion video distribution (advertisement distribution) service may function as a part of the platform service. In this case, the advertisement distribution system 30 may issue a common platform ID to the services so as to be shared by the services of the platform service, and the platform ID may be used as the viewer ID. In this case, the game distribution system 20 may use the platform ID as the player ID. That is, the player ID and the viewer ID may be the same ID.

The type information is information indicating a type of the game. The game advertisement service may be provided for only one type of game, in which case the type information may be omitted, but as an example, the game advertisement service is provided for a plurality of types of games. The type information is used to discriminate the types of those games. The play situation is information indicating the play situation corresponding to the specific game screen 50. The play situation information can appropriately include various types of information indicating the play situation occurring in the game, and includes, for example, information corresponding to a solicitation list required for the advertisement material through advertisement solicitation to be described below. The subject information is information indicating a subject to be provided to the specific game screen 50. An appropriate subject may be provided to the specific game screen 50 for a game advertisement 60, and the subject information is configured according to the subject, but is configured to include a subject of the solicitation list to be described below as an example. Incidentally, the subject may be arbitrarily input by the provider, and in the case, the game application provides an opportunity to input the subject.

The evaluation value information is information indicating an evaluation value calculated as an evaluation result of the play situation corresponding to the specific game screen 50 (in other words, the specific game screen 50). The evaluation value is calculated based on a predetermined logic. The predetermined logic can be appropriately configured for the type of game, various elements that can be included in each game, and the like. For example, when a full-base home run is solicited as a specific play situation in a baseball game, the predetermined logic is configured to use elements such as an inning in which the full-base home run has occurred and a home run batter (a specific player or a batting order such as cleanup may be used). Specifically, for example, even in the play situation corresponding to the same full-base home run, a higher value is calculated as the inning becomes larger such as eighth inning over seventh inning, ninth inning over eighth inning, and the like. Further, the value to be set in each batting order is calculated such that a cleanup batter (main player) becomes the highest in a manner of a third batter over a second batter, the cleanup batter over the third batter, and the like. Then, an average value, a total value, or the like of two values is calculated as the evaluation value based on these two values. Alternatively, for example, when an advertisement is solicited with the solicitation list for the seventh inning and the cleanup batter, a logic may be applied in which a full-base home run by the cleanup batter in the seventh inning has the highest evaluation as perfect matching, and an evaluation value decreases as a difference from the solicitation list becomes large according to the degree of matching with the solicitation list in the order of the cleanup batter in the sixth inning, the cleanup batter in the eighth inning, the third batter in the seventh inning, and the like. Furthermore, a need for a new player (character) is considered, and the evaluation value may be appropriately added according to whether or not the new player is included.

Similarly, for example, when yakuman (Grand Slum) in the mahjong game is specified as a specific play situation, the predetermined logic is configured to use elements such as the type of yakuman, the number of draws until winning, a leader or not, and the type of tile (for example, the presence or absence of honor tiles). Then, for example, a total value or the like of values is calculated as the evaluation value based on a value set to each yakuman according to an appearance probability or the number of appearances (set such that the priority is set to be low for an already distributed role or a role that has already appeared in the past), a value that becomes higher as the number of draws becomes smaller, a value that becomes higher for a leader than for a player (non-leader), and a value set to the type of each tile. The evaluation value may be calculated in another system such as the advertisement distribution system 30, but is calculated by the mobile game machine 3C (mobile application) as an example.

A notification destination is information indicating a notification destination of the provider. The advertisement distribution system may notify the provider of various types of information as necessary, and the notification destination is used at that time. Therefore, when such a notification is omitted, the notification destination information may also be omitted. However, as an example, when the game advertisement 60 including the specific game screen 50 is adopted as a distribution target, the provider is notified of the adoption from the advertisement distribution system. The notification destination information is used for the notification. The notification destination information can appropriately include various types of information according to the notification method from the advertisement distribution system to the provider. As an example, notification of adoption to the distribution target is given to the user terminal device (for example, a device that functions as the mobile game machine 3C and the mobile advertisement device 4C) used by the provider through e-mail. Therefore, the notification destination information includes information of an e-mail address of the provider. Further, the game application also provides an opportunity to input such an e-mail address.

Meanwhile, when acquiring the screen information from the mobile game machine 3C, the advertisement distribution system 30 stores the screen information. Further, the advertisement distribution system 30 generates the game advertisement 60 based on the screen information stored at a predetermined time such as a solicitation deadline for the advertisement solicitation (F3). This generation may be implemented as appropriate, and may be manually implemented, for example, but is automatically implemented as an example. The advertisement distribution system 30 can appropriately implement the automatic generation of the game advertisement 60, and is implemented based on the screen information and a predetermined format for the game advertisement 60 as an example. Specifically, the advertisement distribution system 30 generates the game advertisement 60 by applying the predetermined format based on information of the display data (motion video data), the type, and the subject included in the screen information. Details of the generation of the game advertisement will be described below.

Further, when a plurality of the game screens 50 is provided by one or a plurality of the mobile game machines 3C as the specific game screen 50, the advertisement distribution system 30 may distribute all of the game screens as the game advertisement 60, but distributes only a part of the game screens as the distribution target in the example of FIG. 3. Such a part of the game screens 50 may be selected after the generation of the game advertisement 60, but is selected before the generation of the game advertisement 60 as an example. That is, some of the game screens 50 is selected from the plurality of game screens 50 provided as the specific game screen 50, and the game advertisement 60 is generated based on the selected some of the game screens 50. Such some game screen 50 may be appropriately selected, but is executed based on a selection criterion for selecting an object assumed to have a high advertising effect as an example. The selection based on the selection criterion is performed in the following procedure.

That is, the advertisement distribution system 30 evaluates the evaluation value included in the screen information based on the predetermined selection criterion, and selects each game screen 50. Specifically, the advertisement distribution system 30 selects the game screen 50 to be advertised based on whether the evaluation value exceeds the predetermined value as a selection criterion, so as to select the game screen 50 having the evaluation value higher than a predetermined value as the target game advertisement 60. As an example, the selection based on the selection criterion is performed in such a procedure. Then, the advertisement distribution system 30 notifies the provider of some game screen 50 selected as the distribution target of adoption as the distribution target (advertising target) (F4). This notification may be implemented through the game application or the like, but is implemented through e-mail as described above as an example.

Further, the advertisement distribution system 30 distributes the created game advertisement 60 to the mobile advertisement device 4C so that the game advertisement is inserted at appropriate timing of various motion videos (F5). The motion video to be inserted and the timing may be appropriately decided, but are decided based on a predetermined logic for discriminating a relationship between the type of the motion video or the like and a tendency of the viewer who views the motion video as an example. Specifically, the motion video to be inserted and the timing are decided to be a motion video viewed by a viewer having a tendency of being interested in the game advertisement 60 and a random time of the motion video based on the predetermined logic such that the game advertisement 60 is distributed to the viewer having the tendency of being interested in the game advertisement 60. Then, when the game advertisement 60 is distributed from the advertisement distribution system 30, the mobile advertisement device 4C displays the game advertisement 60 on the monitor MO. As an example, the game advertisement service is implemented by such a procedure.

### (Discrimination of Advertisement Material)

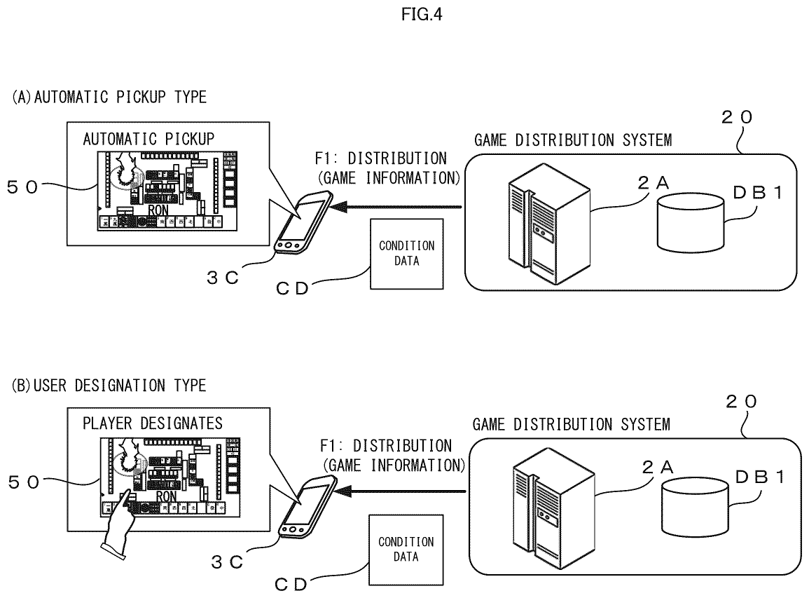

Next, collection of the advertisement material (specific game screen 50) in the mobile game machine 3C will be described with reference to FIG. 4. As described above, the specific game screen 50 as the advertisement material is discriminated in the game application based on the advertisement condition. The advertisement condition can appropriately include various conditions that can specify a part of the series of game screens 50, and includes, for example, a situation designation condition and a designation result condition. The situation designation condition is a condition for automatically discriminating (picking up) the game screen 50 corresponding to a specific play situation designated in advance as the specific game screen 50 when the specific play situation occurs. Information of the specific play situation satisfying the situation designation condition can be appropriately provided from the game distribution system 20 to the mobile game machine 3C, and is provided as the solicitation list of advertisement solicitation as an example.

Meanwhile, the designation result condition is a condition for using a designation result of the player. That is, when the designation result condition is used, the specific game screen 50 (specific play situation) is discriminated (picked up) by the player through designation. The designation of the game screen 50 by the player may be freely executed at any time regardless of the advertisement solicitation, but as an example, the designation can be executed only on the game screen 50 corresponding to the solicitation list according to the advertisement solicitation similarly to the situation designation condition. Specifically, in the case of the game screen 50 indicating the specific play situation corresponding to the solicitation list, the player is provided with a designation opportunity to designate whether to designate the game screen as the advertisement material. Then, when the game screen 50 is designated as the advertisement material in the designation opportunity, the game screen 50 is discriminated as the specific game screen 50. As a result, the method of discriminating the advertisement material includes two methods of an automatic pickup type based on the situation designation condition and a player designation type based on the designation by the player.

FIG. 4 is an explanatory figure for describing the method of discriminating the advertisement material. The example of FIG. 4 illustrates a procedure according to the discrimination method between the game distribution system 20 and the mobile game machine 3C in the example of FIG. 3. Specifically, (A) of the example of FIG. 4 illustrates an automatic pickup type procedure, and (B) illustrates a player designation type procedure. In this case, as illustrated in (A) of FIG. 4, when the advertisement material is discriminated by the automatic pickup type, condition data CD (that may be part of or different from the game information) is distributed from the game distribution system 20. The condition data CD is data in which information of the solicitation list (a condition necessary for discriminating the specific game screen 50) of the advertisement solicitation is described. When acquiring the condition data CD, the mobile game machine 3C automatically discriminates the game screen 50 corresponding to the specific play situation as the specific game screen 50 when the specific play situation satisfying the solicitation list (situation designation condition) described in the condition data CD occurs. In this example, the condition data CD functions as advertisement information of the present invention.

Specifically, the mobile game machine 3C may appropriately execute the discrimination of the specific play situation, but for example, the mobile game machine 3C starts recording of a play log indicating information of the play situation with the start of the game, and performs the discrimination based on the play log. Further, the mobile game machine 3C starts recording of the series of game screens 50 (recording of information necessary for generating replay data such as object configuration and the operation information when the replay data is generated as the display data) at an appropriate time. As such a time, the start of play of the game may be adopted and the series of game screens 50 may be continuously recorded (captured) from the start of play. However, as an example, when the time is designated in the solicitation list, the time corresponding to such a designated condition is used as the start time of recording. That is, for example, when the inning is designated in the baseball game, such as a full-base home run in the last inning, the recording of the series of game screens 50 is started from the designated inning such as the last inning or the like. Alternatively, when winning of yakuman is designated in the mahjong game, for example, recording of the series of game screens 50 is started from a state of ready for the yakuman. Then, the specific game screen 50 corresponding to the specific play situation is acquired from the recorded series of game screens 50. In this case, the recording of a portion (unnecessary portion) other than the specific game screen 50 is erased at an appropriate time. Incidentally, the recording of the game screen 50 or the like may be always executed regardless of a solicitation period of the advertisement solicitation, but is limited to the solicitation period and executed as an example. That is, the recording of the game screen 50 or the like is started at the start of the solicitation period and is ended at the end of the solicitation period.

On the other hand, as illustrated in (B) of FIG. 4, when the advertisement material is specified by the user designation type, the player designates the specific game screen 50 from the series of game screens 50 displayed on the mobile game machine 3C. Specifically, for example, when the designation of the specific game screen 50 is executed regardless of the advertisement solicitation, the distribution of the condition data CD from the game distribution system 20 to the mobile game machine 3C may be omitted, but as an example, the designation is executed similarly to the automatic pickup type. When acquiring the condition data CD, the mobile game machine 3C provides the player a designation opportunity to designate the game screen 50 corresponding to the specific play situation as the specific game screen 50 when the specific play situation corresponding to the solicitation list described in the condition data CD occurs. Then, when the game screen 50 is designated as the specific game screen 50 by the player at the designation opportunity, the designated game screen 50 is discriminated as the specific game screen 50. Also in this case, the mobile game machine 3C may start recording of the series of game screens 50 at an appropriate time, and may start recording from the start of play of the game, for example. However, as an example, similarly to the automatic pickup type, the mobile game machine 3C starts recording according to the solicitation list. The unnecessary portion is similarly treated to the case of the automatic pickup type. As an example, in the automatic pickup type and the player designation type, the specific game screen 50 is picked up from the series of game screens 50 in such a procedure.

### (Condition Data)

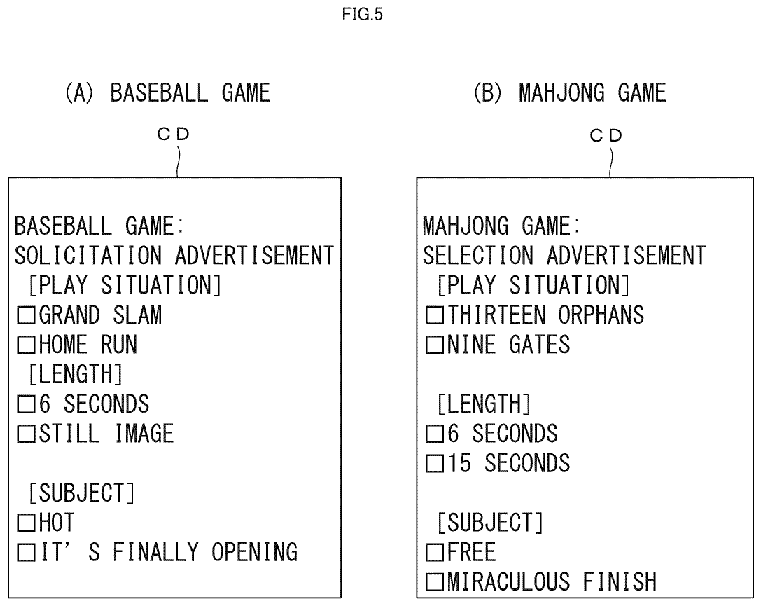

Next, an example of the condition data CD will be described with reference to FIG. 5. FIG. 5 is an explanatory figure for describing an example of content of the condition data CD. The condition data CD may appropriately include various types of information, which may or may not be taught to the player appropriately. The example of FIG. 5 illustrates information taught to the player of the information included in the condition data CD. Further, (A) of the example of FIG. 5 illustrates content of the automatic pickup type case, and (B) illustrates content of the player designation type case. Furthermore, although the mobile game machine 3C can provide various games, (A) of FIG. 5 illustrates a case where the baseball game is provided by the mobile game machine 3C, and (B) of FIG. 5 illustrates a case where the mahjong game is provided by the mobile game machine 3C. As illustrated in (A) of FIG. 5, when the mobile game machine 3C provides the baseball game, the condition data CD includes information of “baseball game”, “solicitation advertisement”, “play situation”, “length”, and “subject”. Among the pieces of information, the information of “baseball game”, “solicitation advertisement”, “play situation”, and “length” functions as the main solicitation list.

The “baseball game” is information indicating the type of game (baseball game). The “solicitation advertisement” is information indicating a solicitation format of advertisement solicitation. The solicitation format may appropriately include various formats for soliciting the advertisement material, and includes two types of formats, for example, the solicitation advertisement and a selection advertisement. The solicitation advertisement is an automatic pickup type solicitation format, that is, a solicitation format in which the specific game screen 50 is automatically discriminated based on the situation designation condition. Meanwhile, the selection advertisement is a player designation type solicitation format, that is, a solicitation format in which the specific game screen 50 is manually discriminated by the designation of the player. The “solicitation advertisement” is information indicating the solicitation format of the solicitation advertisement.

The “play situation” is information indicating the specific play situation (game scene) solicited as the advertisement material. The “play situation” may appropriately include various types of information that can discriminate the specific play situation, and may include, for example, information specifying an element in a game such as a specific character or item. In the example of FIG. 5, information of “grand slam” and “home run” is included. The “grand slam” indicates a situation of a grand slam (full-base home run), and the “home run” indicates a situation of a home run. When the information of the grand slam is described, a situation of the grand slam of the baseball game is specified as the specific play situation, and the game screen 50 corresponding to the grand slam is specified as the specific game screen 50. The same similarly applies to a case where the information of the home run is described.

The “length” is information indicating a length (scale) of the game screen 50 that is solicited as the advertisement material. In the “length”, appropriate time information may be described as the length of the game screen 50. In the example of FIG. 5, information of “6 seconds” and “still image” is described. “6 seconds” is information indicating the length (motion video) of 6 seconds, and is information for soliciting a motion video having the length of 6 seconds as the game screen 50 corresponding to the grand slam. Meanwhile, the “still image” is information indicating a still image, and is information for soliciting a still image as the game screen 50 corresponding to the home run. Since the “length” includes information designating a still image, it also functions as information indicating a type of an image of a motion video and a still image.

The “subject” is information indicating a subject (catch copy) displayed on the game advertisement 60. Various subjects can be appropriately described in the “subject”. In the example of FIG. 5, information of “hot” and “it's finally opening” is described. The “hot” is displayed as the subject when the game screen 50 of the grand slam is used for the game advertisement 60, and “it's finally opening” is displayed as the subject when the game screen 50 of the home run is used for the game advertisement 60. In this example, the information of the type of game and the play situation functions as information of conditions of the present invention.

Meanwhile, as illustrated in (B) of FIG. 5, when the mobile game machine 3C provides the mahjong game, the condition data CD includes information of “mahjong game”, “selection advertisement”, “play situation”, “length”, and “subject”. These pieces of information are similar to those in the case of the baseball game, but the “mahjong game” indicates the mahjong game as the type of game, and “selection advertisement” indicates the solicitation format of the selection advertisement. Furthermore, in the “play situation”, information indicating specific yakuman such as “Thirteen Orphans” and “Nine Gates” is described as the specific play situations that can occur in the mahjong game, and in the “length”, information indicating lengths such as “6 seconds” and “15 seconds” (both are motion videos) is described.

Similarly, in the “subject”, information of “free” and “miraculous finish” are described as the subjects. The “miraculous finish” is information directly indicating the subject similarly to the “hot” and the like, but the “free” is information that allows free input of the subject. When the information of “free” is described in the “subject”, for example, the player is provided with an opportunity to input the subject, and the subject input there is displayed in the game advertisement 60. Further, in the case of the selection advertisement, the subject information also functions as information for prompting the player to understand the specific play situation to be discriminated as the advertisement material. Incidentally, the condition data CD is not limited to the above examples, and may include various types of information necessary for advertisement solicitation or specification of the game advertisement 60. For example, the condition data CD may include reward information, such as a case where a different reward is provided according to the content or the like in association with provision of the advertisement material. Similarly, for example, the condition data CD may include information of the number of adopted people when there is a limit to the number of game advertisements 60 to be adopted. Alternatively, each piece of the above information may be omitted as appropriate.

### (Solicitation Announcement Screen)

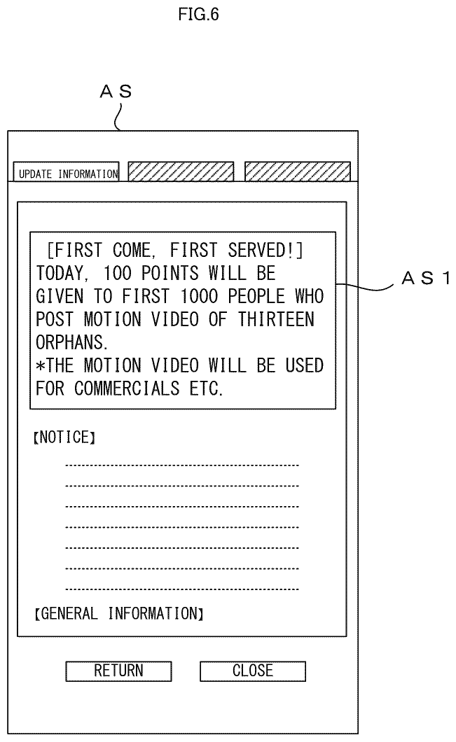

Next, a solicitation announcement screen will be described with reference to FIG. 6. FIG. 6 is a figure schematically illustrating an example of the solicitation announcement screen. When the advertisement material (specific game screen 50) of the game advertisement 60 is collected based on the advertisement solicitation, the advertisement solicitation may be notified by an appropriate method such as e-mail, but as an example, the advertisement solicitation is notified through the solicitation announcement screen. Such a solicitation announcement screen may be implemented as appropriate, and for example, may be implemented through a game application as one of information provision services. As an example, the solicitation announcement screen is implemented through a website provided by the game distribution system 20. Specifically, the game distribution system 20 constructs and distributes a web site for providing various types of information regarding the game provided by the mobile game machine 3C, and the mobile game machine 3C accesses the web site through a browser application for browsing the web site and displays the solicitation announcement screen. The example of FIG. 6 illustrates the solicitation announcement screen in such a case.

As illustrated in FIG. 6, a solicitation announcement screen AS includes an advertisement solicitation field AS1. The advertisement solicitation field AS1 is a field for displaying information related to the advertisement solicitation. Although various types of information regarding the advertisement solicitation can be appropriately displayed in the advertisement solicitation field AS1, the example of FIG. 6 displays the information regarding the solicitation lists. Specifically, information of the play situation to be sought, the number of available people, reward, and use of the solicitation list, such as “Thirteen Orphans”, “First 1000 people”, “100 points will be given”, and “Motion videos will be used for commercials and the like” is displayed as the information on the solicitation list. The information in the advertisement solicitation field AS1 may be created as appropriate, and may be created, for example, by input by the operator of the game distribution system 20. As an example, the information is created by applying items (the pieces of information of the condition data CD) according to the solicitation list to the fixed phrase prepared in advance. For this reason, when the solicitation announcement screen AS of FIG. 6 is displayed, for example, the condition data CD may include information of the number of persons on a first-come basis (or the number of adopted persons) such as “for the first 1000 users” and a reward such as “100 points”.

(Reward Associated with Provision of Advertisement Material)

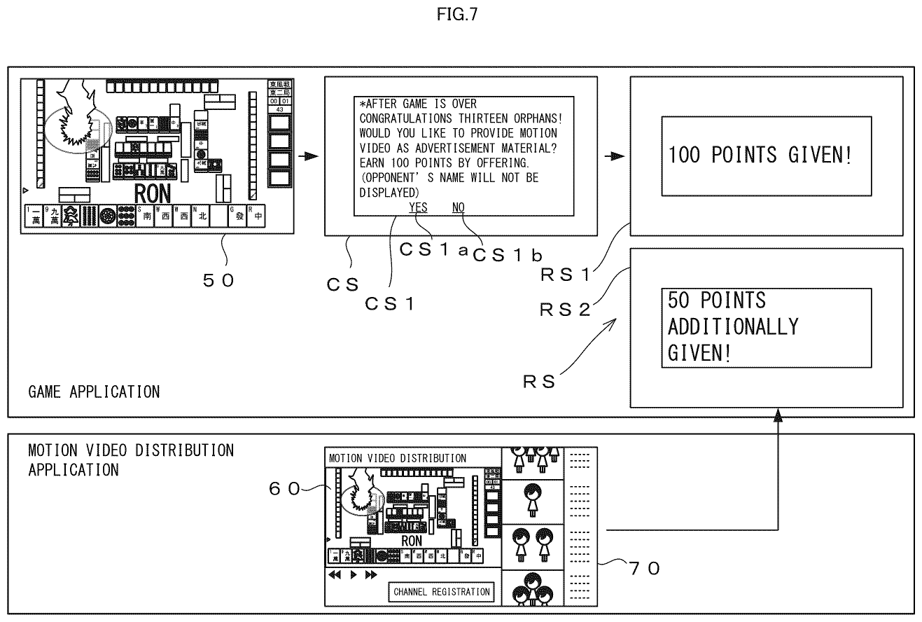

Next, a reward associated with provision of the advertisement material (specific game screen 50) will be described with reference to FIG. 7. FIG. 7 is an explanatory figure for describing an example of a reward associated with provision of the advertisement material. FIG. 7 schematically illustrates an example of transition of a screen of a game application related to provision of the advertisement material and a motion video distribution screen 70 displayed on a motion video distribution application. Further, the example of FIG. 7 illustrates a case where the specific game screen 50 is discriminated by the automatic pickup type. In this case, as illustrated in FIG. 7, the game screen 50, a permission screen CS, and a reward provision screen RS are sequentially displayed as screens related to the provision of the advertisement material on the mobile game machine 3C through the game application.

The game screen 50 is the specific game screen 50 corresponding to the specific play situation among the series of game screens 50. In the automatic pickup type, the specific game screen 50 is automatically discriminated based on the condition data CD as described above. The permission screen CS is a screen for permitting use of the specific game screen 50 for the game advertisement 60. The use permission for the game advertisement 60 may be implemented as appropriate, and may be uniformly executed regardless of whether the advertisement material is actually provided at the start of play of the game, for example. In the case, the permission screen CS may be displayed at the start of play. As an example, the permission screen CS is displayed after the specific game screen 50 is discriminated. Similarly, the permission screen CS may be appropriately configured. In the example of FIG. 7, the permission screen CS includes a permission explanation field CS1. The permission explanation field CS1 is a field for displaying various explanations related to the use of the specific game screen 50 for the game advertisement 60. Various explanations may be appropriately displayed in the permission explanation field CS1. In the example of FIG. 7, a sentence for confirming the presence or absence of provision to the game advertisement 60 and a sentence for explaining the reward are displayed.

Furthermore, the permission explanation field CS1 is provided with a “Yes” button CS1a and a “NO” button CS1b for expressing an intention regarding whether to permit provision. Various input systems for inputting an instruction of the player such as the play action may be appropriately provided in the mobile game machine 3C. As an example, a touch panel that detects a position according to a touch operation of the player is provided, and both the “Yes” button CS1a and the “NO” button CS1b function as positions where the touch operation is to be executed. Then, the “Yes” button CS1a functions as an option indicating permission, and the “NO” button CS1b functions as an option indicating non-permission. That is, when the “Yes” button CS1a is selected, the specific game screen 50 is provided to the advertisement distribution system 30 as the advertisement material for the game advertisement 60. On the other hand, when the “NO” button CS1b is selected, provision of the specific game screen 50 to the advertisement distribution system 30 (eventually, the use in the game advertisement 60) is canceled.

The reward provision screen RS is a screen for displaying a reward provided by the provision of the advertisement material (specific game screen 50). Various benefits may be appropriately provided as the reward corresponding to the provision of the advertisement material, and for example, a physical benefit may be provided. As an example, an electronic benefit is provided. The electronic benefit may appropriately include various electronic elements, and can include, for example, appropriate elements such as an item in the game, an increase in parameters set for a character, various values in the game, or various rights (qualification) such as favorable treatment of the progress of the game and play of special development. In the example of FIG. 7, a point is provided as the electronic benefit (an example of a predetermined element).

The point may function as an appropriate value. For example, the point may function as either a value that functions as a predetermined consideration when the game is played in exchange for the predetermined consideration or a value used in the game. In the example of FIG. 7, the point functions as both of the values. That is, with the provision of the advertisement material, a predetermined amount of points that can be used for both the consideration for play and purchase of an item or the like in the game are provided to the provider of the advertisement material as the reward. Such points may be issued by the game distribution system 20. As an example, the points are issued by the advertisement distribution system 30. Further, when the advertisement distribution system 30 provides a platform service, the points function as points shared in each service of the platform service.

Further, the predetermined amount of points as the reward may be a fixed amount or a variable amount. For example, the same amount (fixed amount) of points may be uniformly provided with the provision of the advertisement material, or different amounts (variable amounts) of points may be provided in accordance with content of the advertisement material. As an example, both the fixed amount and the variable amount are provided. The fixed amount and the variable amount may be provided at an appropriate time such as the time of providing the advertisement material, and may be provided at the same time. As an example, the fixed amount is provided at the time of providing the advertisement material, and the variable amount is provided afterwards.

Specifically, the reward provision screen RS includes an initial reward provision screen RS1 and a post-reward provision screen RS2. The initial reward provision screen RS1 is the reward provision screen RS displayed at the time of providing the advertisement material in order to display points (hereinafter may be referred to as an initial reward) of a fixed amount (for example, 100 points) provided as the reward at the time of providing the advertisement material. Meanwhile, the post-reward provision screen RS2 is the reward provision screen RS displayed afterward in order to display points (hereinafter may be referred to as an additional reward) of a variable amount (for example, 50 points) provided afterward as the reward. The additional reward (variable amount) may be appropriately calculated based on the content of the advertisement material, and may be calculated, for example, based on an appropriate logic using a predetermined evaluation criterion or the like. In the example of FIG. 7, the additional reward (variable amount) is calculated according to the advertising effect (advertisement achievement) as the game advertisement 60.

The advertising effect may be discriminated as appropriate. For example, when the game advertisement 60 is configured to be linked to a website prepared for downloading the game application to the mobile game machine 3C, the advertising effect may be discriminated according to the number of links or the number of times that the game application has been actually downloaded from the link. In the example of FIG. 7, the advertising effect is discriminated according to the number of distributions (distribution result) as the number of game advertisements 60 distributed to the mobile advertisement device 4C. That is, the additional reward is calculated according to the number of distributions of the game advertisement 60. Specifically, the additional reward is calculated such that the larger the number of distributions (the higher the advertising effect), the larger the point amount (the higher the value).

The game advertisement 60 is distributed through a motion video distribution screen 70. Further, the motion video distribution screen 70 may be appropriately displayed on the mobile advertisement device 4C. In the example of FIG. 7, the motion video distribution screen 70 is displayed through a motion video distribution application. The motion video distribution application is an application for causing the mobile advertisement device 4C to function as a device that displays a motion video (in other words, an advertisement). Therefore, the post-reward provision screen RS2 is displayed after the game advertisement 60 is actually distributed to the mobile advertisement device 4C through the motion video distribution screen 70 of the motion video distribution application.

Further, the additional reward may be calculated at an appropriate time, and may be calculated in a constant cycle such as every predetermined period (an ending time limit of counting may be appropriately set or the calculation may be continued during the distribution of the game advertisement 60). As an example, the additional reward is set in a plurality of stages such that the reward amount increases as the number of distributions increases according to the number of distributions, and the reward amount (point amount) set in each stage is calculated as the additional reward every time the number of distributions reaches each stage. Then, the post-reward provision screen RS2 is displayed to notify the calculated additional reward. That is, the post-reward provision screen RS2 is displayed so as to notify the additional reward to be provided as a bonus according to the distribution result every time the number of distributions reaches each stage.

For example, when a site for confirming points is prepared, the post-reward provision screen RS2 may be displayed through an appropriate application (for example, a browser application or the like) that can access the site. As an example, the post-reward provision screen is displayed through the game application. Further, when the provider of the advertisement material inputs the player ID or the viewer ID in the game application after the calculation of the additional reward, the post-reward provision screen RS2 is displayed by a pop-up or a predetermined operation for confirming various notifications. As an example, such a reward is provided with the provision of the advertisement material.

### (Designating Method of Player Designation Type)

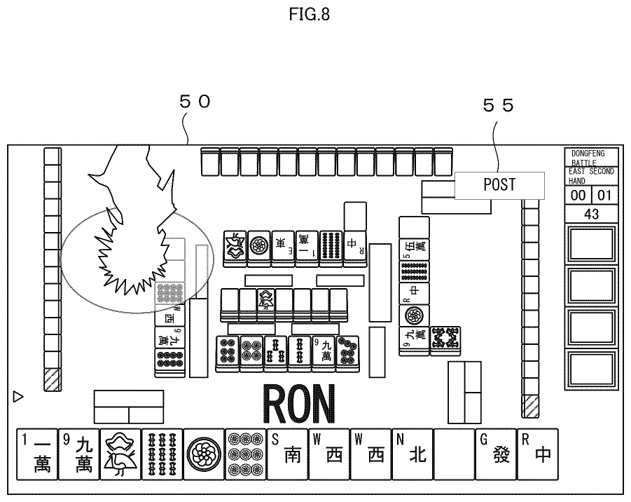

Next, a designation method when the advertisement material is discriminated in the player designation type will be described with reference to FIG. 8. The designation of the advertisement material may be appropriately implemented through various operations that can be input to the mobile game machine 3C. As an example, the designation is implemented through a touch operation on the game screen 50. FIG. 8 is a figure schematically illustrating an example of the game screen 50 when the advertisement material is discriminated in the player designation type. As illustrated in FIG. 8, when the advertisement material is discriminated in the player designation type, a material designation button 55 is provided on the game screen 50. The material designation button 55 is an image indicating a position where the touch operation for designating the game screen 50 currently displayed as the advertisement material is to be executed.

The material designation button 55 may be always displayed on a series of the game screens 50 when the player is allowed to perform designation at an arbitrary time, or the like. As an example, when advertisement solicitation is executed, the material designation button is displayed only on the game screen 50 corresponding to the solicitation list of the advertisement solicitation. For example, when yakuman is solicited in mahjong, the material designation button 55 is displayed on the game screen 50 corresponding to the winning of yakuman. Further, after the material designation button 55 is touched and operated, the permission screen CS and the reward provision screen RS are sequentially displayed as in the example of FIG. 7. In this example, the touch operation on the material designation button 55 functions as a designation instruction of the present invention.

### (Generation of Game Advertisement)

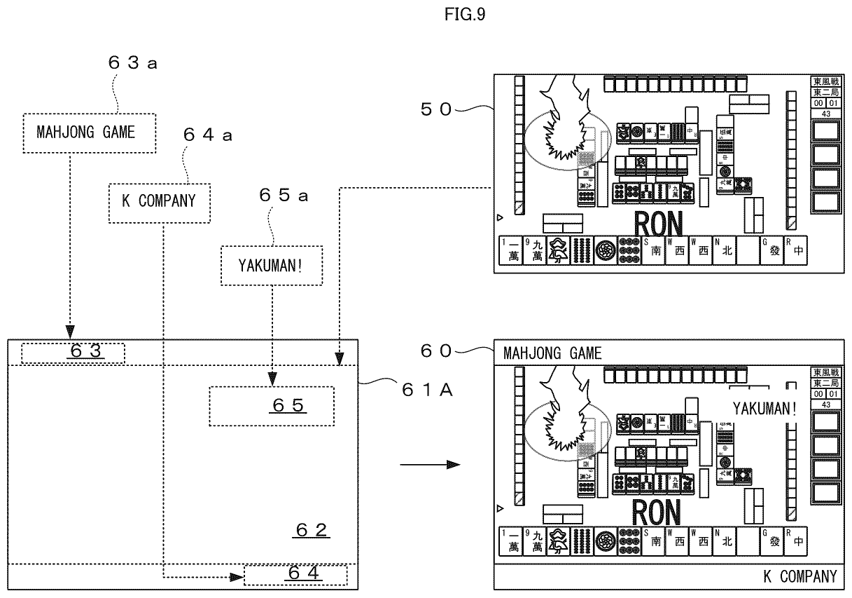

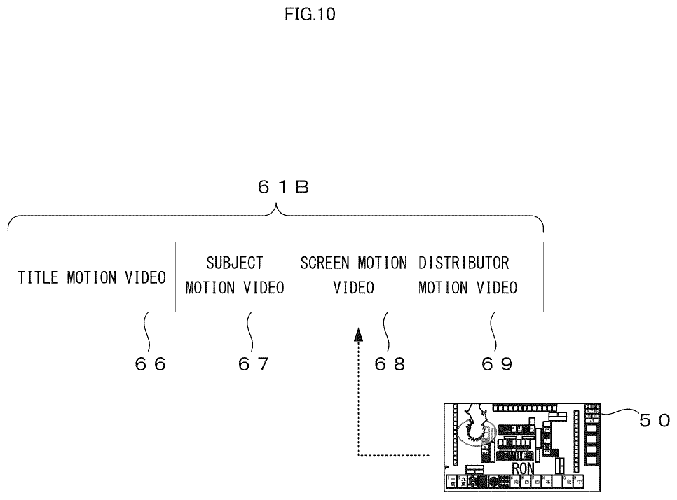

Next, generation of the game advertisement 60 will be described with reference to FIGS. 9 to 11. FIGS. 9 and 10 are both explanatory figures for describing generation of the game advertisement 60. Although the game advertisement 60 can be generated as appropriate, the example of FIG. 9 is an explanatory figure for describing generation of the game advertisement 60 according to a first method. The game advertisement 60 is generated based on the predetermined format and the screen information as described above. The first method is applied to generation of the game advertisement 60 that simultaneously displays pieces of information of the screen information. Specifically, the example of FIG. 9 illustrates a case where the game advertisement 60 is generated by combining the predetermined format (template) prepared as a fixed form in which arrangement positions of the game screen 50 and the like are set in advance and information to be arranged at each arrangement position of the format. Further, the game advertisement 60 may include appropriate information. The example of FIG. 9 illustrates a case of including a game name, a distributor name of the game (including a logo indicating the distributor name, and the like), a subject, and the game screen 50.

As illustrated in FIG. 9, a format 61A according to the first method includes a game screen area 62, a game name area 63, a distributor area 64, and a subject area 65. The game screen area 62, the game name area 63, the distributor area 64, and the subject area 65 are areas (portions) in which the game screen 50, a game name 63a, a distributor name 64a, and a subject 65a are to be arranged, respectively. Therefore, information of the game name 63a and the like is embedded in these areas 62 to 65, and the game advertisement 60 is generated.

Further, although a uniform format may be used as the predetermined format 61A regardless of the type of game and the play situation, a plurality of the formats 61A corresponding to a plurality of play situations that can occur for each type of game is prepared as an example. An appropriate difference may occur between the formats 61A. For example, a difference in position, range, or size may occur in all or some of the game name area 63, the distributor area 64, and the subject area 65. As an example, a difference occurs in the position or the like of the subject area 65. Such a difference may be appropriately set. As an example, the subject area 65 is set to be arranged at a position or the like where an influence on the play situation indicated by the game screen 50 is relatively small. That is, a plurality of formats 61A in which at least some of the position, range, or size of the subject area 65 are different from each other is prepared according to the play situation. Then, the format 61A corresponding to the play situation is used for generating the game advertisement 60 based on the play situation of the game screen 50 provided as the advertisement material.

The game name 63a, the distributor name 64a, and the subject 65a to be arranged in the game name area 63, the distributor area 64, and the subject area 65 may be prepared as appropriate. As an example, the game name area 63 and the distributor area 64 are prepared for each type of game. Meanwhile, the game screen 50 and the subject 65a are displayed based on the screen information (or screen data to be described below) transmitted from the mobile game machine 3C. Specifically, the game screen 50 of the game screen area 62 is displayed based on the display data included in the screen information, and the subject 65a is displayed based on the subject information included in the screen information. Then, the information of the game name 63a, the distributor name 64a, and the subject 65a is arranged in the game name area 63, the distributor area 64, and the subject area 65 of the format 61A according to the play situation, respectively, and the game advertisement 60 is generated.

Meanwhile, an example of FIG. 10 is an explanatory figure for describing generation of the game advertisement 60 according to a second method. The second method is applied to generation of the game advertisement 60 that sequentially displays each piece of information of the screen information. The example of FIG. 10 illustrates an example of a format 61B according to the second method. Further, the example of FIG. 10 illustrates the format 61B when applied to the game advertisement 60 including portions that sequentially displays the game name, the subject, the game screen 50, and the distributor name of the game, similarly to the example of FIG. 9. Furthermore, these pieces of information may be displayed in an appropriate order. The example of FIG. 10 illustrates the format 61B when the information is displayed in order of the game name, the subject, the game screen 50, and the distributor name of the game. In this case, as illustrated in FIG. 10, the format 61B according to the second method is formed as a motion video having a length corresponding to the game advertisement 60 so as to sequentially include a title motion video 66, a subject motion video 67, a screen motion video 68, and a distributor motion video 69.

The title motion video 66, the subject motion video 67, and the distributor motion video 69 are motion video portions for respectively displaying the game name (title), the subject, and the distributor name in the game advertisement 60. Therefore, the title motion video 66 is prepared in advance for each type of game (or for each way of displaying the game name. The same similarly applies to other information), the subject motion video 67 is prepared in advance for each subject, and the distributor motion video 69 is prepared in advance for each distributor. Therefore, each format 61B is formed by a combination of the title motion video 66 and the like prepared according to the type of game and the like. Incidentally, the title motion video 66, the subject motion video 67, and the distributor motion video 69 may be formed as needed through insertion of the information of the game name, subject, and distributor name managed by appropriate data. For example, when the advertisement distribution system 30 has the condition data CD such as the case where the game distribution system 20 functions as the advertisement distribution system 30, the game name and the subject managed by the condition data CD may be appropriately inserted similarly to the screen motion video 68 to be described below, and the title motion video 66 and the subject motion video 67 may be formed every time the game advertisement 60 is generated. The same similarly applies to the distributor motion video 69.

Meanwhile, the screen motion video 68 is a motion video image portion for displaying the game screen 50. Although audio such as narration may be included in advance in the screen motion video 68, the game screen 50 provided as the advertisement material is incorporated afterward. That is, the game screen 50 is incorporated in the screen motion video 68 of the format 61B prepared for each game and each subject (corresponding to the play situation), and the game advertisement 60 is generated. The plurality of formats 61B can be appropriately prepared as the formats 61B according to the second method. As an example, such a format 61B is prepared, and the game advertisement 60 is generated by a combination with the game screen 50 or the like. In this example, the game screen area 62 or the screen motion video 68 functions as a screen portion of the present invention. Incidentally, in the following description, when the format 61A according to the first method and the format 61B according to the second method are not distinguished, the formats 61A and 61B may be referred to as format(s) 61 as a representative.

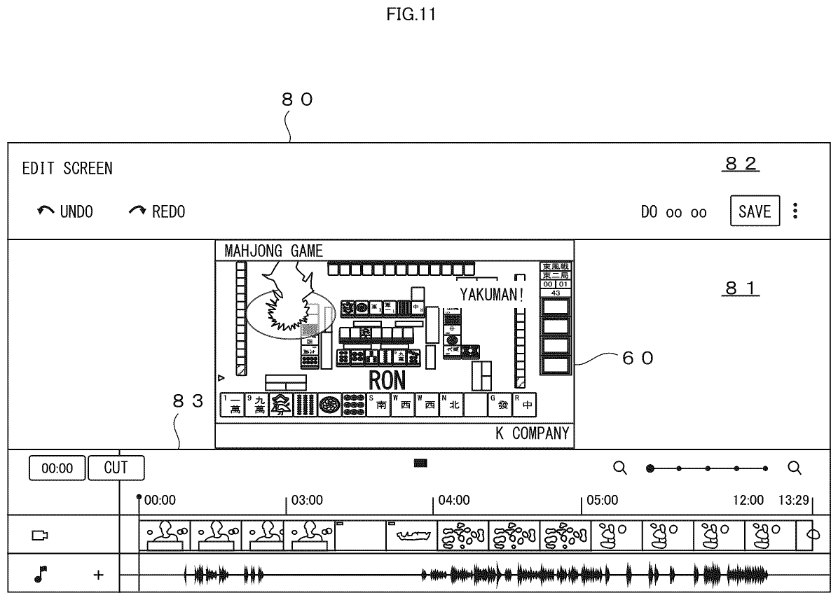

FIG. 11 is a figure schematically illustrating an example of an edit screen. The edit screen is a screen for editing the specific game screen 50 or the game advertisement 60. The specific game screen 50 may be used as the game advertisement 60 without being edited, and in the case, the edit screen may be omitted. Further, when the specific game screen 50 is edited, the specific game screen 50 may be edited at an appropriate time, for example, may be provided as the advertisement material, then stored in the advertisement distribution system 30, and edited after accessing the advertisement distribution system 30 afterwards, or may be edited before or after the use permission on the permission screen CS. That is, the edit screen may be displayed afterwards via the advertisement distribution system 30 or may be displayed before or after the use permission, for example. As described above, the edit screen can be appropriately utilized (or omitted). As an example, the edit screen is used for editing the game advertisement 60. Further, such editing through the edit screen may be executed through an appropriate application such as a browser application or a game application in the mobile game machine 3C, for example. As an example, the editing is executed by the operator of the game distribution system 20. That is, the edit screen is displayed on the game distribution system 20. The example of FIG. 11 illustrates an edit screen in such a case.

As illustrated in FIG. 11, an edit screen 80 includes an advertisement area 81, a first edit area 82, and a second edit area 83. The first edit area 82 and the second edit area 83 are areas for instructing various types of editing, but different instructions are assigned to the respective areas. Specifically, the first edit area 82 is an area to which an instruction to save or redo edited content is assigned. Meanwhile, the second edit area 83 is an area to which an instruction to edit the length or range of the game screen 50 included in the game advertisement 60, superimposed display of another material (including another game screen 50), or a camera angle or the like when the game screen 50 is displayed based on the replay data is assigned. Therefore, the first edit area 82 and the second edit area 83 are appropriately provided with instruction buttons corresponding to these instructions such as saving.

Meanwhile, the advertisement area 81 is an area for displaying a motion video to be edited. When the game advertisement 60 is edited, the game advertisement 60 is displayed as an edit target in the advertisement area 81. Further, when editing is executed through the first edit area 82 and the second edit area 83, the edited game advertisement 60 is displayed in the advertisement area 81. That is, the editing executed through the first edit area 82 and the second edit area 83 is reflected in the advertisement area 81 in real time. As an example, the game advertisement 60 is edited through such an edit screen 80. Incidentally, the edit screen 80 is used as a confirmation screen when editing is not performed, but when an edit opportunity is omitted, a simple confirmation screen (for example, a screen in which the edit function of the edit screen 80 is omitted) may be provided instead of the edit screen 80.

### (Configuration of Main Part of Control System)

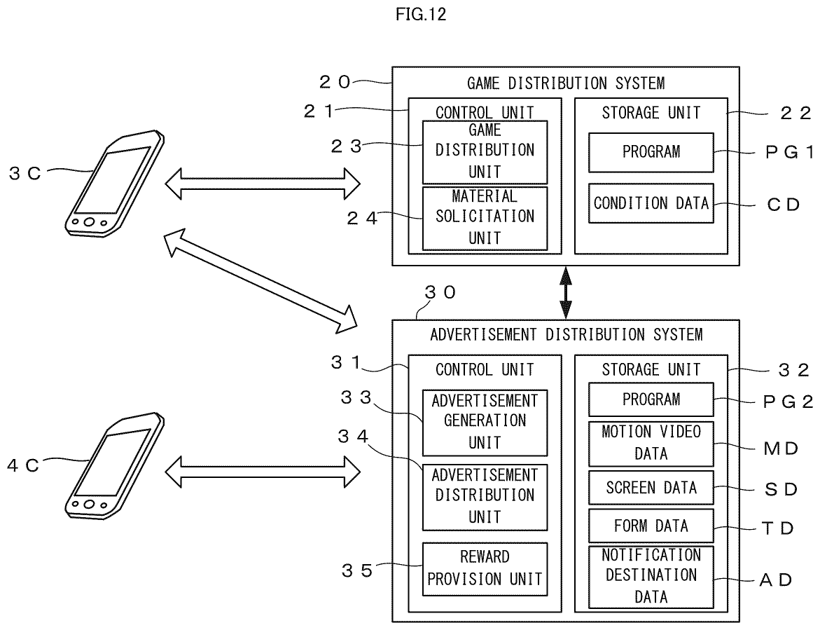

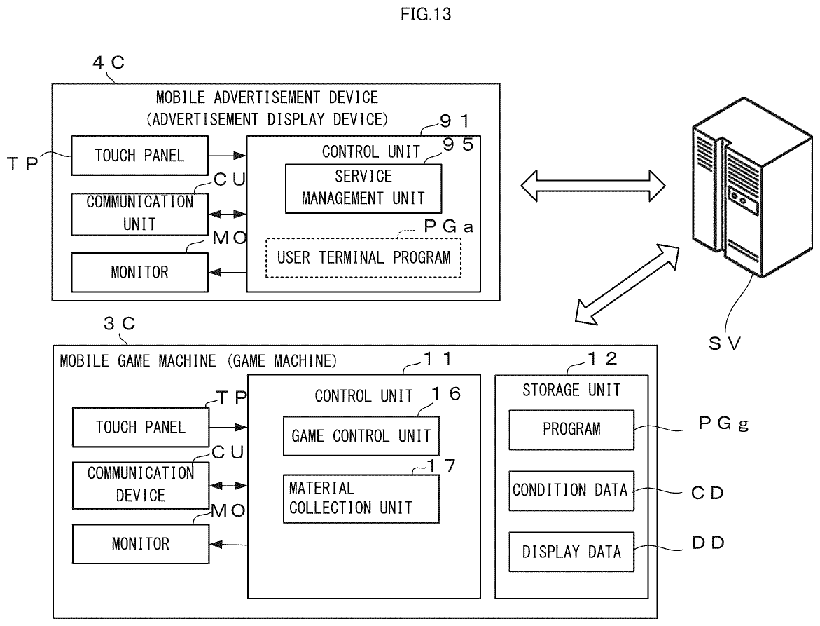

Next, a configuration of a main part of a control system related to the game advertisement service in the network system 1 will be described with reference to FIGS. 12 and 13. FIG. 12 illustrates an example of a main part of a control system in the server SV. Incidentally, the configuration of FIG. 12 is one of specific examples of the configuration of the network system 1 of FIG. 2, and components corresponding to those of FIG. 2 are denoted by the same reference numerals as those in FIG. 2.

As illustrated in FIG. 12, the game distribution system 20 includes a control unit 21 and a storage unit 22. The storage unit 22 is configured by a storage unit including a non-volatile storage medium (computer-readable storage medium) such as a hard disk array. The storage unit 22 stores a computer program PG1 and data to be referred to by the control unit 21. Such data can appropriately include various types of data. The condition data CD is illustrated in the example of FIG. 12. The condition data CD is data in which the information of the solicitation list when the specific game screen 50 is solicited as the advertisement material is described.

The control unit 21 is configured using computer hardware resources (for example, a CPU and the like) of one or a plurality of the server units 2. In the control unit 21, various logical devices are configured by a combination of the hardware resources constituting the control unit 21 and the computer program PG1. In the example of FIG. 12, a game distribution unit 23 and a material solicitation unit 24 are provided as the logical devices related to the game advertisement service.

The game distribution unit 23 is a logical device that performs various types of processing necessary for the mobile game machine 3C to provide a game. Such processing includes, for example, processing of matching each mobile game machine 3C (player) when a common game is played in a plurality of the mobile game machines 3C, and processing of sharing various types of game information such as a progress status and an operation status in each mobile game machine 3C. Similarly, the processing executed by the game distribution unit 23 includes, for example, processing of distributing play data for handing over a previous play record to the next play, and collecting a consideration when collection of the consideration is necessary.

The material solicitation unit 24 is a logical device that performs various types of processing related to solicitation of the advertisement material. Such processing includes processing of generating the condition data CD based on information input by an operator and distributing the condition data CD to the mobile game machine 3C (the actual distribution may be executed via the game distribution unit 23, and includes provision to the game distribution unit 23 in the that case). In this example, the server unit 2 constituting the game distribution system 20 functions as a server device of the present invention.

The advertisement distribution system 30 includes a control unit 31 and a storage unit 32. The storage unit 32 is configured by a storage unit including a non-volatile storage medium (computer-readable storage medium) such as a hard disk array. The storage unit 32 stores a computer program PG2 and data to be referred to by the control unit 31. Such data can appropriately include various data, and the example of FIG. 12 illustrates motion video data MD, screen data SD, form data TD, and notification destination data AD.

The motion video data MD is data for displaying various motion videos (including an image in the case of a still image). The various motion videos include a motion video for a motion video distribution service and the game advertisement 60 to be appropriately inserted into the motion video. The game advertisement 60 further includes the specific game screen 50. Therefore, the motion video data MD includes the display data (motion video data) for displaying the specific game screen 50. That is, the motion video data MD functions as data for displaying the motion video for motion video distribution, the game screen 50, and the game advertisement 60. Further, when a plurality of the game screens 50 is transmitted from the mobile game machine 3C as the game screen 50 for the game advertisement 60, the motion video data MD includes a plurality of pieces of display data for displaying the plurality of game screens 50.

The screen data SD is data for managing the information regarding the specific game screen 50 of the advertisement materials. Such information appropriately includes various types of information such as information necessary for managing the game screen 50, and includes, for example, the screen information transmitted from the mobile game machine 3C. Details of the screen data SD will be described below.

The form data TD is data for defining the predetermined format 61 for generating the game advertisement 60. According to the form data TD, each format 61A in which the position and the like of the subject area 65 differ according to the play situation or each format 61B in which the title motion video 66 and the like differ is implemented. Details of the form data TD will be described below.

The notification destination data AD is information for managing the notification destination of each player. The notification destination information can be used as appropriate, and is used to notify the provider of the specific game screen 50 of adoption as the distribution target when, for example, the specific game screen 50 is selected as the distribution target. Details of the notification destination data AD will be described below.

The control unit 31 is configured using computer hardware resources of one or a plurality of the server units 2. In the control unit 31, various logical devices are configured by a combination of the hardware resources constituting the control unit 31 and the computer program PG2. The example of FIG. 12 illustrates an advertisement generation unit 33, an advertisement distribution unit 34, and a reward provision unit 35 as the logical devices related to the game advertisement service.

The advertisement generation unit 33 is a logical device that performs various types of processing related to generation of an advertisement. Such an advertisement includes the game advertisement 60. Therefore, processing executed by the advertisement generation unit 33 includes various types of processing related to generation of the game advertisement 60. Such processing includes, for example, processing of acquiring the specific game screen 50 from the mobile game machine 3C, discriminating the format 61 according to the play situation corresponding to the specific game screen 50, and arranging appropriate information in a predetermined location (portion) of the format 61. As an example of such processing, the advertisement generation unit 33 executes screen information acquisition processing and game advertisement generation processing. Details of procedures of the screen information acquisition processing and the game advertisement generation processing will be described below.

The advertisement distribution unit 34 is a logical device that performs various types of processing related to distribution of an advertisement to the mobile advertisement device 4C. The advertisement may be appropriately distributed to the mobile advertisement device 4C. As an example, as described above, the game advertisement 60 is distributed so as to be inserted into the motion video distributed via the motion video distribution service. Therefore, processing executed by the advertisement distribution unit 34 includes, for example, processing of distributing the motion video to the mobile advertisement device 4C and distributing the game advertisement 60 so as to be inserted at an appropriate time of the motion video. Further, when the game screen 50 (game advertisement 60) to be distributed is selected after the generation of the game advertisement 60, the processing executed by the advertisement distribution unit 34 includes processing related to the selection of some of the game screens 50.

The reward provision unit 35 is a logical device that performs various types of processing related to provision of a reward corresponding to provision of the advertisement material. The advertisement material includes the specific game screen 50, and the point is provided to the provider as an example of the reward with the provision of the specific game screen 50, as described above. Further, the reward includes the initial reward (fixed amount of points) and the additional reward (variable amount of points). Therefore, processing executed by the reward provision unit 35 includes processing of providing the initial reward and the additional reward. The reward provision unit 35 executes initial reward provision processing and additional reward provision processing as an example of such processing. Details of procedures of the initial reward provision processing and the additional reward provision processing will be described below.

Meanwhile, FIG. 13 illustrates an example of main parts of control systems in the mobile game machine 3C and the mobile advertisement device 4C. As illustrated in FIG. 13, the mobile advertisement device 4C includes a control unit 91 configured as a computer unit including a microprocessor and an internal storage device necessary for operation of the microprocessor. Various input devices or output devices can be connected to the control unit 91. In the example of FIG. 13, a touch panel TP, a communication device CU, and a monitor MO are connected. Each of the touch panel TP, the communication device CU, and the monitor MO is general-purpose hardware provided in an information communication terminal such as a smartphone.

The control unit 91 is provided with a service management unit 95 as a logical device implemented by a combination of the hardware and a predetermined user terminal program PGa. The service management unit 95 is a logical device provided along with execution of a motion video distribution application program included in the user terminal program PGa. The service management unit 95 executes various types of processing related to the motion video distribution service, and such processing includes processing for displaying the game advertisement 60 to be appropriately inserted into a motion video. Incidentally, the mobile advertisement device 4C can be appropriately provided with various types of hardware such as a storage unit that stores the user terminal program PGa as external storage devices for the control unit 91 and an output devices such as a speaker, but illustration thereof is omitted.

The mobile game machine 3C is provided with the control unit 11 and the storage unit 12. Further, various input devices and output devices can be appropriately connected to the control unit 11. In the example of FIG. 13, a touch panel TP, a communication device CU, and a monitor MO are connected, similarly to the mobile advertisement device 4C. Each of the touch panel TP, the communication device CU, and the monitor MO is general-purpose hardware provided in an information communication terminal such as a smartphone, as described above. In this example, the touch panel TP and the monitor MO function as an input device and a display device of the present invention, respectively.

The storage unit 12 is configured by a storage unit including a non-volatile storage medium (computer-readable storage medium) such as a hard disk array. The storage unit 12 stores a computer program PGg and data to be referred to by the control unit 11. Such data can appropriately include various types of data. The condition data CD and the motion video data MD are illustrated in the example of FIG. 13.

As described above, the condition data CD is data in which the information related to the solicitation list when the game screen 50 for the game advertisement 60 is solicited is described. Display data DD is motion video data for displaying the specific game screen 50 (motion video) provided as the advertisement material. Incidentally, when a still image is provided as the specific game screen 50, the display data DD functions as image data for displaying the still image. In this example, the display data DD functions as display data of the present invention.

The control unit 11 is configured as a computer unit including a microprocessor and an internal storage device necessary for the operation thereof. In the control unit 11, various logical devices are configured by a combination of the hardware and the computer program PGg, and in the example of FIG. 13, a game control unit 16 and a material collection unit 17 are illustrated as the logical devices related to the game advertisement service.

The game control unit 16 is a logical device that performs various types of processing necessary for providing a game. Such processing includes, for example, processing of acquiring various game information from the game distribution system 20 and displaying the series of game screens 50 on the monitor MO based on the game information.

The material collection unit 17 is a logical device that performs various types of processing related to collection of the specific game screen 50 as the advertisement material. Such processing includes processing of acquiring the condition data CD from the game distribution system 20 (including a case of directly acquiring the condition data from the game distribution system 20 and a case of indirectly acquiring the condition data via the game control unit 16) and discriminating the specific game screen from the series of game screens 50 based on the condition data CD. Further, processing executed by the material collection unit 17 includes processing of providing the specific game screen 50 to the advertisement distribution system 30 so as to be utilized as the advertisement material, and providing an opportunity to edit the game screen 50 and the like. The material collection unit 17 executes material collection processing and solicitation information acquisition processing as an example of such processing. Details of procedures of the material collection processing and the solicitation information acquisition processing will be described below.

### (Details of Various Data)

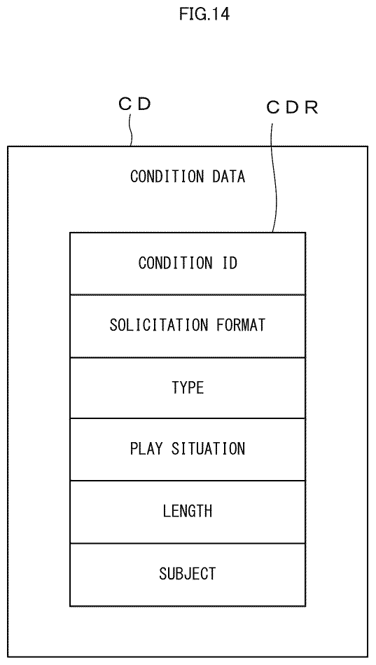

Next, details of the condition data CD, the screen data SD, the form data TD, and the notification destination data AD will be described with reference to FIGS. 14 to 17. FIG. 14 is a figure illustrating an example of a configuration of the condition data CD. The condition data CD can appropriately include various types of information regarding the solicitation list for the advertisement solicitation. The example of FIG. 14 illustrates a portion related to the information illustrated in the example of FIG. 5. In this case, as illustrated in FIG. 14, the condition data CD includes a condition record CDR for managing the solicitation list for each advertisement solicitation. Further, the condition record CDR includes information of “condition ID”, “solicitation format”, “type”, “play situation”, “length”, and “subject” in order to implement such management.

The “condition ID” is information indicating a unique condition ID for each advertisement solicitation for identifying the each advertisement solicitation. The “solicitation format”, the “type”, the “play situation”, the “Length”, and the “subject” are information corresponding to the solicitation format, the game type, the play situation, the length, and the subject of the example of FIG. 5, respectively. Therefore, the information indicating “solicitation advertisement” or “selection advertisement” is described in the “solicitation format”, and the information indicating the game type such as “baseball game” or “mahjong game” is described in the “type”. Similarly, the information indicating the specific play situation such as “grand slam” is described in the “play situation”, the information indicating the length such as “6 seconds” is described in the “length”, and the information indicating the subject such as “hot” is described in the “subject”.

Incidentally, the condition record CDR is not limited the example, and may include appropriate information according to convenience of the solicitation list or the like. For example, the condition record CDR may include detailed information. The detailed information is information for explaining details of the specific play situation as the solicitation list. For example, in the detailed information, information for describing the play situation with a higher evaluation value or information for explaining details of the specific play situation when a situation of a type that cannot be sufficiently grasped by the player is designated as the specific play situation (in other words, as the specific game screen 50 to be designated) in the “play situation” is described. Alternatively, each piece of the above information may be omitted as appropriate.

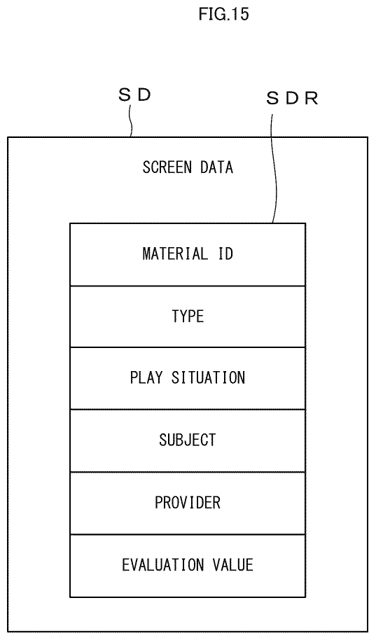

FIG. 15 is a figure illustrating an example of a configuration of the screen data SD. The screen data SD can appropriately include various types of information for managing each game screen 50 (advertisement material). The example of FIG. 15 illustrates a portion related to the screen information provided from the mobile game machine 3C. As illustrated in FIG. 15, the screen data SD includes a screen record SDR for managing the information of the game screen 50 for each game screen 50 as the advertisement material. Further, the screen record SDR includes information of “material ID”, “type”, “play situation”, “subject”, “provider”, and “evaluation value” in order to implement such management.

The “material ID” is information indicating a unique material ID for each game screen 50 in order to identify the each game screen 50 provided as the advertisement material. Meanwhile, the “type”, “play situation”, “subject”, “provider”, and “evaluation value” are information respectively indicating the game type, the play situation, the subject, the provider, and the evaluation value included in the screen information.

Specifically, the “type” is information indicating the game type corresponding to each game screen 50. In the “type”, various types of information can be appropriately described as information of the game type. As an example, information of the game name is described. Further, the information of “type” is used when the game screens 50 of a plurality of types of games are collected as the advertisement materials, and may be omitted when the game screen 50 of only one type of game is collected as the advertisement material.

The “play situation” is information indicating the play situation corresponding to each game screen 50. In the “play situation”, the play situation may be appropriately described according to various games, and for example, in the case of the baseball game, the play situation including an at-bat result such as a hit, a home run, or a full-base home run, a batter such as the cleanup batter, or an inning such as the seventh inning is described. Similarly, in the case of the mahjong game, information of a winning hand such as Thirteen Orphans, the number of draws, a type of tile in the winning hand, an east round, and the like is described as the play situation.

The “subject” is information of the subject (catch copy) to be given to each game screen 50. In the information of the subject, the information of the subject set to each game screen 50 in the condition data CD such as “hot” or “miraculous finish” is described.

The “provider” is information indicating the provider (player) who has provided each game screen 50 as the advertisement material. In the “provider”, appropriate information capable of identifying each user such as the player ID can be described. As an example, information of the viewer ID is described. Further, the “evaluation value” is information indicating the evaluation value of each game screen 50. These pieces of information are recorded in the screen record SDR so as to be associated with each other. Incidentally, the screen record SDR is not limited the example, and may include appropriate information according to convenience of the solicitation list or the like. Alternatively, each piece of the above information may be omitted as appropriate. Further, for example, when the game distribution system 20 functions as the advertisement distribution system 30, or the like, the condition data CD may be used instead of the screen data SD, and in this case, the screen data SD may be omitted. That is, the condition data CD may be appropriately used as the screen data SD (or a part of the screen information) in the advertisement distribution system 30 or the like.

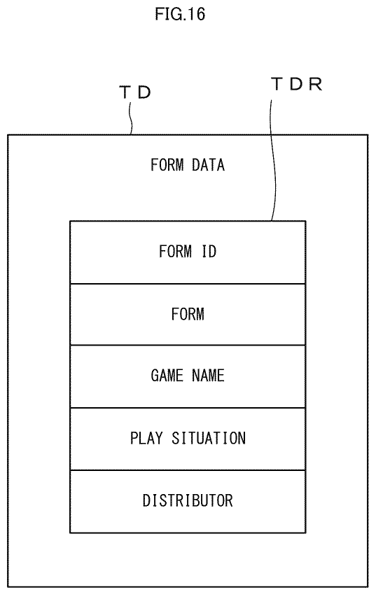

FIG. 16 is a figure illustrating an example of a configuration of the form data TD. The form data TD can appropriately include various types of information according to the specification (form) of the game advertisement 60 and the like. The example of FIG. 16 illustrates a portion necessary for generation of the game advertisement 60 of the example of FIG. 9. As illustrated in FIG. 16, the form data TD includes a form record TDR for managing an object to which the format 61 (form) is to be applied for the each format 61. Further, the form record TDR includes information of “form ID”, “form”, “game name”, “play situation”, and “distributor” in order to implement such management.

The “form ID” is information indicating a unique form ID for each format 61 in order to identify the each format 61. The “form” is information that defines the form (content) to be implemented as the each format 61. Each format 61 may be implemented as appropriate, for example, may be implemented by adding another area to the game name area 63, the distributor area 64, and the subject area 65 in the example of FIG. 9, or may be implemented by omitting a part of the areas, on the contrary. As an example, the format 61 is implemented by a difference in position, range, or size of the game name area 63, the distributor area 64, and the subject area 65. More specifically, the specific form of each format 61A is defined such that the position or the like of the subject area 65 differs according to the play situation for each game. Therefore, in the “form”, information indicating the position, range, and size of the subject area 65 is described as an example. Further, in the case of the format 61B according to the second method, information indicating a combination of the title motion video 66, the subject motion video 67, the screen motion video 68, and the distributor motion video 69 prepared for the each format 61B can be described in the “form”, and information indicating the screen motion video 68 associated with the “game name”, “play situation”, and “distributor” is described.

The “game name” is information indicating the game name. The game name also functions as information indicating the game type. The “play situation” is information indicating the play situation in each game similarly to the “play situation” in the example of FIG. 15. The “distributor” is information indicating the distributor of each game. In the “distributor”, for example, information of “company K” of the distributor name 64a is described in the case of the example of FIG. 9. Meanwhile, in the case of the format 61B according to the second method, the “game name”, “play situation”, and “distributor” function as information for specifying the title motion video 66, the subject motion video 67, and the distributor motion video 69.

Incidentally, the form record TDR is not limited to the example, and may include appropriate information according to the form or the like required for the game advertisement 60. Alternatively, each piece of the above information may be omitted as appropriate. For example, when the condition data CD is described instead of the screen data SD, the information of the condition ID may be described instead of the information of the “game name”, “play situation”, and “distributor”. In this case, in the “form” of the format 61B according to the second method, for example, information indicating a combination of the title motion video 66, the subject motion video 67, the screen motion video 68, and the distributor motion video 69 may be described instead of the information indicating the screen motion video 68.

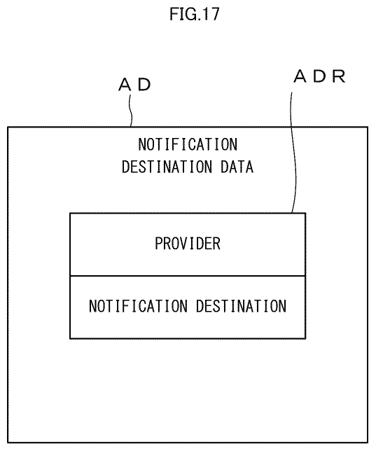

FIG. 17 is a figure illustrating an example of a configuration of the notification destination data AD. The notification destination data AD can appropriately include various types of information necessary for notification to each user. The example of FIG. 17 illustrates a portion related to notification of adoption executed for the provider of the game screen 50 adopted for the game advertisement 60 to be distributed. As illustrated in FIG. 17, the notification destination data AD includes a notification destination record ADR for managing the notification destination for each provider. Further, the notification destination record ADR includes information of “provider” and “notification destination” in order to implement such management.

The “provider” is the provider similarly to the example of FIG. 15, and as an example, information of the viewer ID is described in the “provider”. The “notification destination” is information indicating the notification destination of each provider. In the “notification destination”, various types of information can be appropriately described as the notification destination, and for example, the player ID or the like when the notification is made through a game application may be described. As an example, address information of an e-mail is described. Incidentally, the notification destination record ADR is not limited the example, and may include appropriate information necessary for the notification to each user. Alternatively, each piece of the above information may be omitted as appropriate.

### (Processing of Network System)

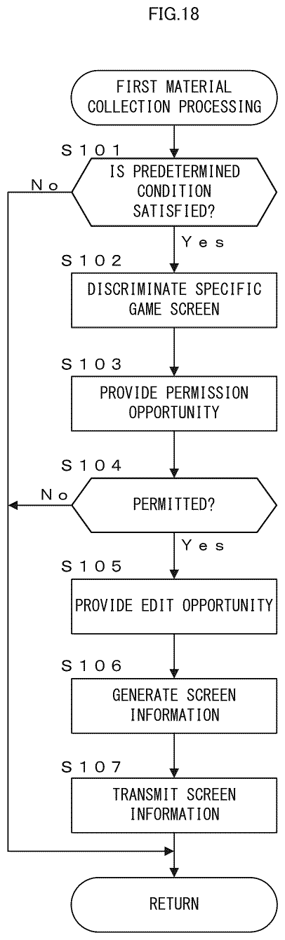

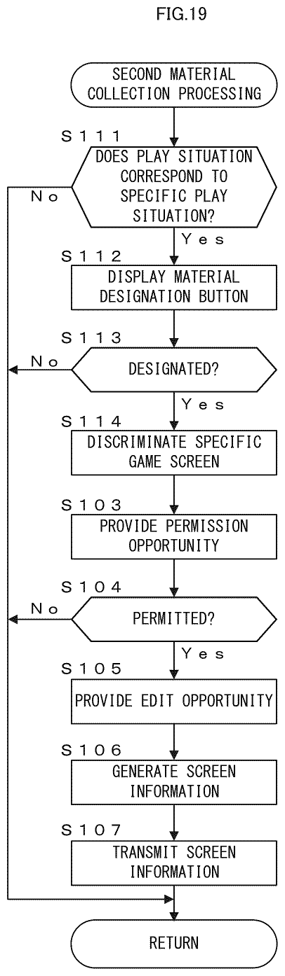

Next, the material collection processing, the solicitation information acquisition processing, the screen information acquisition processing, the game advertisement generation processing, the initial reward provision processing, and the additional reward provision processing executed in the network system 1 in relation to the game advertisement service will be described with reference to FIGS. 18 to 24. The material collection processing is processing for discriminating the specific game screen 50 as the advertisement material from the series of game screens 50. The method for discriminating the advertisement material includes the two methods of the automatic pickup type and the player designation type. These methods may be implemented as appropriate, but as an example, the methods are implemented by different pieces of processing. Therefore, the material collection processing includes first material collection processing for implementing the automatic pickup type and second material collection processing for implementing the player designation type. The example of FIG. 18 illustrates an example of a procedure of the first material collection processing, and the example of FIG. 19 illustrates an example of a procedure of the second material collection processing. Further, both examples of FIGS. 18 and 19 illustrate a case where the specific game screen 50 as the advertisement material is directly transmitted to the advertisement distribution system 30. Moreover, provision of the edit opportunity to edit the specific game screen 50 may be omitted, but both of FIGS. 18 and 19 illustrate the case where the edit opportunity is provided to the player.

When discrimination of the advertisement material is executed by the automatic pickup type, the material collection unit 17 starts the first material collection processing of FIG. 18 every time an operation by the player is executed, and discriminates whether the play situation after the operation satisfies the advertisement condition (predetermined condition) (step S101). In the case of the automatic pickup type, the situation designation condition is used as the advertisement condition, and the situation designation condition is satisfied when the play situation after the operation corresponds to the specific play situation corresponding to the solicitation list. Further, the solicitation list is described in the condition data CD. Therefore, while referring to the condition data CD, the material collection unit 17 first discriminates whether the play situation after the operation corresponds to the specific play situation (“play situation” of the condition data CD) corresponding to the solicitation list of the advertisement solicitation. Then, when the play situation does not correspond to the specific play situation, that is, when the situation designation condition is not satisfied (step S101: No), the material collection unit 17 skips the subsequent processing and terminates the current first material collection processing.

On the other hand, when the play situation after the operation corresponds to the specific play situation, that is, when the situation designation condition is satisfied (step S101: Yes), the material collection unit 17 discriminates the game screen 50 indicating the play situation after the operation among the series of game screens 50, that is, the game screen 50 corresponding to the specific play situation, as the specific game screen 50 as the advertisement material (step S102).

Subsequently, the material collection unit 17 provides the permission opportunity (step S103). The permission opportunity can be implemented as appropriate, and is implemented through the permission screen CS as an example. Therefore, the material collection unit 17 implements provision of the permission opportunity by displaying the permission screen CS on the monitor MO. Next, the material collection unit 17 discriminates whether the provision of the specific game screen 50 as the advertisement material has been permitted in the permission opportunity (permission screen CS) (step S104). Specifically, the material collection unit 17 discriminates that the provision is permitted when the “Yes” button CS1a is selected, and discriminates that the provision is not permitted when the “NO” button CS1b is selected, on the permission screen CS. Then, when the provision as the advertisement material is not permitted, that is, when the “NO” button CS1b is selected (step S104: No), the material collection unit 17 skips the subsequent processing and terminates the current first material collection processing.

On the other hand, when the provision of the specific game screen 50 as the advertisement material is permitted, that is, when the “Yes” button CS1a is selected (step S104: Yes), the material collection unit 17 provides the player with the edit opportunity (step S105). The edit opportunity may be implemented as appropriate. For example, when replay data is prepared, the edit opportunity may include editing of the camera angle when the specific game screen 50 is drawn. As an example, the edit opportunity is implemented by displaying a screen corresponding to the edit screen 80 in the example of FIG. 11.

Subsequently, the material collection unit 17 generates the screen information necessary for providing the specific game screen 50 (the edited game screen 50 when edited) as the advertisement material to the advertisement distribution system 30 (step S106). Image information includes, for example, information of the display data DD (motion video data) for displaying the specific game screen 50, the viewer ID, the game type, the play situation, the evaluation value, and the notification destination. Therefore, the material collection unit 17 generates the screen information including these pieces of information. Specifically, the material collection unit 17 calculates the evaluation value of the specific game screen 50, for example. Further, for example, when the information that requires input by the player, such as the viewer ID and the notification destination, has not been acquired, the material collection unit 17 provides an opportunity to acquire the information in step S106. Furthermore, when the player does not have the viewer ID, the material collection unit 17 accesses the advertisement distribution system 30 in step S106 and waits for generation of the screen information until the viewer ID is issued by the advertisement distribution system 30.

Subsequently, the material collection unit 17 transmits the screen information generated in step S106 to the advertisement distribution system 30 (step S107). As a result, the specific game screen 50 corresponding to the solicitation list of the advertisement solicitation is automatically discriminated, and is transmitted as the advertisement material to the advertisement distribution system 30 after the permission of the player and the provision of the edit opportunity. That is, the procedure of F2 in the example of FIG. 3 (or the example of FIG. 4) when the discrimination of the advertisement material is executed in the automatic pickup type is implemented. In the example, the situation designation condition functions as a predetermined condition of the present invention.

Meanwhile, when the discrimination of the advertisement material is executed in the player designation type, the second material collection processing is executed. In the example of FIG. 19, processing of steps S111 to S114 is executed instead of steps S101 and S102 as compared with the example of FIG. 18. Specifically, the material collection unit 17 starts the second material collection processing of FIG. 19 every time the operation by the player is executed, and first discriminates whether the play situation after the operation corresponds to the specific play situation (“play situation” of the condition data CD) while referring to the condition data CD (step S111). The discrimination is executed similarly to the discrimination executed in step S101 in the example of FIG. 18 as an example.

Subsequently, the material collection unit 17 displays the material designation button 55 at a predetermined position (for example, upper right or the like) on the game screen 50 corresponding to the specific play situation (step S112). Next, the material collection unit 17 discriminates whether the game screen 50 has been designated as the specific game screen 50 through a touch operation on the material designation button 55 (whether the designation result condition is satisfied) before the display of the game screen 50 corresponding to the specific play situation is finished (step S113). Then, when the designation as the specific game screen 50 is not executed (when the designation result condition is not satisfied), that is, when the touch operation is not executed on the material designation button 55 (step S113: No), the material collection unit 17 skips the subsequent processing and terminates the current second material collection processing.

On the other hand, when the designation as the specific game screen 50 has been executed (when the designation result condition is satisfied), that is, when the touch operation has been executed on the material designation button 55 (step S113: Yes), the material collection unit 17 discriminates the game screen 50 on which the touch operation has been executed on the material designation button 55 as the specific game screen 50 (step S114). Thereafter, the material collection unit 17 executes processing similar to steps S103 to S107 in the example of FIG. 18, and terminates the current second material collection processing after the processing of step S107. As a result, the material designation button 55 is displayed only on the game screen 50 corresponding to the solicitation list of the advertisement solicitation, and the specific game screen 50 is manually discriminated by the player through the operation on the material designation button 55. Then, similarly to the case where the discrimination of the advertisement material is executed in the automatic pickup type, the specific game screen 50 is transmitted as the advertisement material to the advertisement distribution system 30 after permission and editing by the player. That is, the procedure of F2 in the example of FIG. 3 (or the example of FIG. 4) when the discrimination of the advertisement material is executed in the player designation type is implemented.

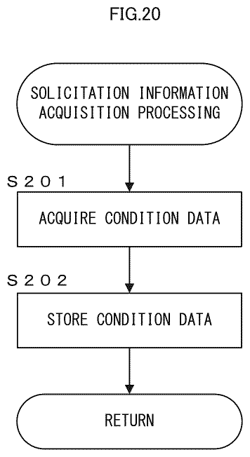

The solicitation information acquisition processing is processing for acquiring the information of the solicitation list for the advertisement solicitation. As an example, the solicitation list is described in the condition data CD, as described above. Therefore, the solicitation information acquisition processing is executed as processing for acquiring the condition data CD. The example of FIG. 20 illustrates a procedure of the solicitation information acquisition processing in such a case. In this case, the material collection unit 17 starts the solicitation information acquisition processing of FIG. 20 every time the condition data CD is transmitted from the game distribution system 20, and first acquires the condition data CD (step S201). Subsequently, the material collection unit 17 stores the acquired condition data CD in the storage unit 12 in order to utilize the condition data CD in appropriate processing such as the material collection processing (step S202). Then, after the storage, the material collection unit 17 terminates the current solicitation information acquisition processing. As a result, the information of the condition data CD (solicitation list) necessary for the discrimination of the specific game screen 50 as the advertisement material is acquired and stored so as to be utilized in the material collection processing and the like.

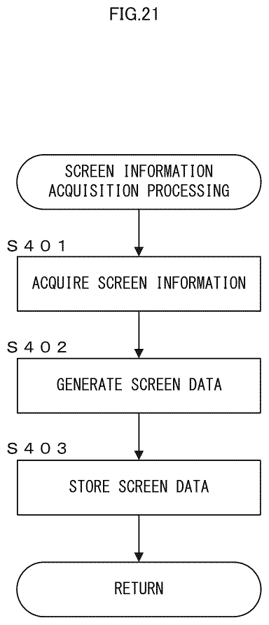

The screen information acquisition processing is processing for generating the screen data SD. When the screen data SD includes the screen information, the screen data SD is generated based on the screen information from the mobile game machine 3C. The example of FIG. 21 illustrates a procedure of the screen information acquisition processing in such a case. In this case, when the screen information is transmitted from the mobile game machine 3C, the advertisement generation unit 33 starts the screen information acquisition processing of FIG. 21, and first acquires the transmitted screen information (step S401).

Subsequently, the advertisement generation unit 33 generates the screen data SD based on the acquired screen information (step S402). Specifically, the advertisement generation unit 33 first assigns the material ID to the specific game screen 50 (image data) included in the screen information, and generates the screen record SDR corresponding to the material ID (adds the screen record SDR to the screen data SD). Subsequently, the advertisement generation unit 33 describes the information of the game type, the play situation, and the viewer ID included in the screen information in the “type”, “play situation”, and “provider” of the generated screen record SDR, respectively. As an example, the advertisement generation unit 33 generates (updates) the screen data SD in this manner.

Subsequently, the advertisement generation unit 33 stores the screen data SD generated in step S402 in the storage unit 32 so as to be utilized in other processing (step S403). Then, after the storage, the advertisement generation unit 33 terminates the current screen information acquisition processing. As a result, the screen information is acquired from the mobile game machine 3C, and the screen data SD is generated based on the screen information.

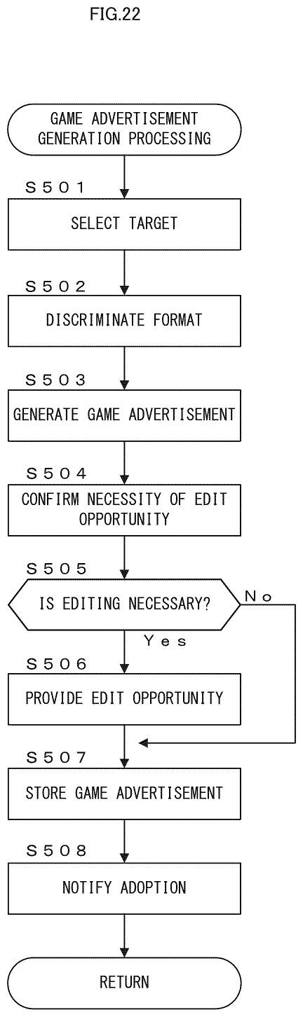

The game advertisement generation processing is processing for generating the game advertisement 60 based on the specific game screen 50. Although the editing of the game advertisement 60 can be appropriately omitted, the example of FIG. 22 illustrates the game advertisement generation processing when the edit opportunity is provided. Further, the game advertisement 60 may be generated at an appropriate time such as the end of the solicitation period of the advertisement solicitation, for example. The example of FIG. 22 illustrates a case where the game advertisement 60 is generated in accordance with a predetermined start instruction for generating the game advertisement 60 by the operator of the game distribution system 20. In this case, the advertisement generation unit 33 starts the game advertisement generation processing of FIG. 22 in accordance with the predetermined start instruction (including an instruction to designate the target advertisement material such as the condition ID when each game screen 50 is associated with the condition ID via the game, the play situation, the screen data SD, or the like), and first selects the target to be used as the advertisement material of the game advertisement 60 with reference to the screen data SD and the like based on the instruction to designate the target included in the start instruction (step S502). Specifically, the advertisement generation unit 33 selects some game screens 50 among the plurality of specific game screens 50 as the targets to be advertised according to whether the evaluation value of each specific game screen 50 exceeds a predetermined value as the selection criterion.

Next, the advertisement generation unit 33 discriminates the format 61 to be applied to the target (game screen 50) discriminated in step S502 (step S502). Specifically, the advertisement generation unit 33 refers to the “type”, “play situation”, and the like of the screen data SD and the “game name”, “play situation”, and the like of the form data TD, specifies the format (“form”) associated with the “type” and “play situation” of the screen data SD via the form data TD, and discriminates the specified format as the format to be used this time.

Subsequently, the advertisement generation unit 33 combines the format 61 discriminated in step S502 with the game screen 50 selected in step S501, and generates the game advertisement 60 (step S503). Specifically, for example, when the format 61A according to the first method is applied, the advertisement generation unit 33 generates the game advertisement 60 by arranging the game screen 50, the game name 63a, the distributor name 64a, and the subject 65a in the game screen area 62, the game name area 63, the distributor area 64, and the subject area 65, respectively. Meanwhile, when the format 61B according to the second method is applied, the advertisement generation unit 33 generates the game advertisement 60 by incorporating the game screen 50 selected in step S501 into the screen motion video 68 among the portions forming the format 61B. The advertisement generation unit 33 also implements the generation with reference to the screen data SD and the form data TD.

Next, the advertisement generation unit 33 checks necessity of the edit opportunity via the game distribution system 20 (step S504), and when an answer indicating that edit is necessary is received via the game distribution system 20 (step S505: Yes), the advertisement generation unit 33 provides the edit opportunity via the game distribution system 20 (step S506). Specifically, the edit opportunity is provided by providing the edit screen 80 to the operator via the game distribution system 20.

After providing the edit opportunity, or when it is determined that edit is unnecessary in view of the necessity of the edit opportunity (step S505: Yes), the advertisement generation unit 33 stores the game advertisement 60 (step S507). When the edit opportunity is provided, an edit result is reflected in the game advertisement 60. Therefore, in this case, the edited game advertisement 60 is stored.

Subsequently, the advertisement generation unit 33 notifies the provider of the game screen 50 included in the game advertisement 60 of the adoption to the game advertisement 60 (step S508). The notification is executed based on the notification destination data AD. Specifically, the advertisement generation unit 33 implements the notification by referring to the information of the “provider” of the screen data SD and the information of the “notification destination” of the notification destination data AD and transmitting an e-mail (for example, a fixed phrase) to the provider of the target game screen 50. Then, after the notification, the advertisement generation unit 33 terminates the current game advertisement generation processing. As a result, the game advertisement 60 in the format 61 corresponding to the specific game screen 50 is automatically generated. Further, when edit is necessary for the game advertisement 60, the edit opportunity is provided. The provider of the material (game screen 50) of the game advertisement 60 is notified of the adoption of the material in the game advertisement 60. That is, the procedures of F3 and F4 in the example of FIG. 3 are implemented.

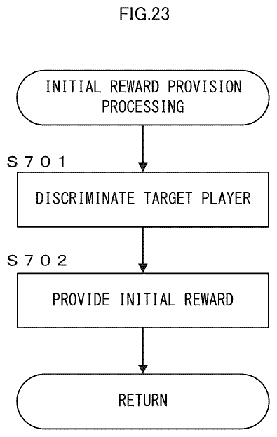

The initial reward provision processing is processing for providing the initial reward to the provider of the advertisement material. Although the initial reward may be provided at an appropriate time, the example of FIG. 23 illustrates the initial reward processing when the initial reward is provided immediately after the sending along with the sending of the advertisement material. In this case, when acquiring the screen information from the mobile game machine 3C, the reward provision unit 35 starts the initial reward provision processing of FIG. 23, and first discriminates the target player to which the initial reward is to be provided (step S701). This discrimination is executed based on the information of the provider included in the screen information, and when the information of the viewer ID is included as the information of the provider, the viewer with the viewer ID is discriminated as the target player.

Subsequently, the reward provision unit 35 provides the initial reward to the player (the viewer with the viewer ID) discriminated in step S701 (step S702). The initial reward may be appropriately changed according to the content (for example, the evaluation value) of the advertisement material or the like. As an example, the initial reward is uniformly set to the same fixed amount of points regardless of the content of the advertisement material. Therefore, the reward provision unit 35 provides the fixed amount of points as the initial reward to the viewer with the viewer ID discriminated in step S701. Then, after the provision, the reward provision unit 35 terminates the current initial reward provision processing. As a result, the initial reward is provided with the provision of the specific game screen 50 as the advertisement material. Incidentally, with the provision of the initial reward, the mobile game machine 3C is notified of the provision result, and the mobile game machine 3C displays the initial reward provision screen RS1 based on the notification and notifies the content of the initial reward.

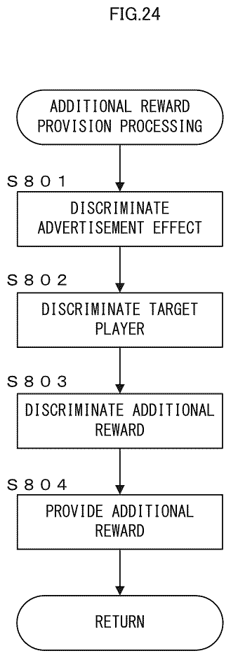

The additional reward provision processing is processing for providing the additional reward to the provider of the advertisement material. The content of the additional reward may be set as appropriate. As an example, the content is set in a plurality of stages according to the number of distributions. The example of FIG. 24 illustrates the additional reward provision processing in such a case. In this case, the reward provision unit 35 starts the additional reward provision processing in FIG. 24 every time the number of distributions of each game advertisement 60 reaches each stage, and first discriminates the advertising effect of the target game advertisement 60 (the game advertisement 60 of which the number of distributions reaches any of the plurality of stages) (step S801). As described above, the advertising effect is discriminated based on the number of distributions as an example. Therefore, in step S801, the reward provision unit 35 discriminates the number of distributions of the target game advertisement 60 as the advertising effect.

Subsequently, the reward provision unit 35 discriminates a target player to which the additional reward is to be provided (step S802). The target player is the provider of the game screen 50 (advertisement material) included in the target game advertisement 60. Therefore, the reward provision unit 35 discriminates the provider of the game screen 50 included in the target game advertisement 60 as the target player while referring to the screen data SD. Specifically, the reward provision unit 35 discriminates the provider of the game screen 50 included in the target game advertisement 60 while referring to the information of the “material ID” and the “provider” of the screen data SD. The information on the viewer ID as the provider is described in the “provider” of the screen data SD. Therefore, the reward provision unit 35 discriminates the viewer with the viewer ID described in the “provider” as the target player.

Next, the reward provision unit 35 discriminates the additional reward to be provided to the target player (step S803). As described above, the content of the additional reward is set in the plurality of stages according to the number of distributions as an example. Therefore, the reward provision unit 35 first discriminates which stage of the plurality of stages the number of distributions discriminated in step S801 corresponds to. Thereafter, the reward provision unit 35 discriminates the reward amount set at the discriminated stage. As an example, the discrimination is implemented based on a table that associates each stage of the plurality of stages with the reward amount of each stage. That is, the reward provision unit 35 discriminates the reward amount at the stage corresponding to the number of distributions discriminated in step S801 as the additional reward while referring to the table.

Subsequently, the reward provision unit 35 provides the target player (viewer) discriminated in step S802 with the additional reward discriminated in step S803 (step S804). Then, after the provision, the reward provision unit 35 terminates the current additional reward provision processing. As a result, the additional reward is provided to the provider who has provided the advertisement material of each game advertisement 60 according to the advertising effect (the number of distributions) of each game advertisement 60. Incidentally, the mobile game machine 3C may be notified of the addition of the additional reward, and the mobile game machine 3C may notify the content of the additional reward by displaying the post-reward provision screen RS2 at an appropriate time based on the notification.

As described above, according to the embodiment, the mobile game machine 3C discriminates the specific game screen 50 that satisfies the advertisement condition among the series of game screens 50 according to the play situation generated according to the play action of the player. Further, the mobile game machine 3C generates the image information including information such as the display data DD for displaying the specific game screen 50, and transmits the image information to the advertisement distribution system 30. Meanwhile, the advertisement distribution system 30 acquires the image information from the game system for use of the specific game screen 50 as the advertisement material. That is, the specific game screen 50 generated in the play of the player is provided from the mobile game machine 3C to the advertisement distribution system 30, and the advertisement distribution system 30 acquires the game screen for use as the advertisement material. Moreover, the advertisement distribution system 30 discriminates the format 61 according to the play situation included in the screen information, incorporates the specific game screen 50 of the display data DD in the format 61, and generates the game advertisement 60. That is, the game advertisement 60 is automatically generated based on the specific game screen 50 and the format 61 corresponding to the play situation of the specific game screen 50. Then, the game advertisement 60 is distributed as the advertisement to the advertisement display device.

Because of the above circumstances, the specific game screen generated by the play of each player can be utilized as the advertisement material for game advertisement. Therefore, time and effort for preparing the advertisement material can be reduced. In addition, since use of various game screens such as a latest game screen and a more attractive game screen as the advertisement materials can be promoted, the advertising effect can be improved. Furthermore, since it is possible to meet the needs of players who have a desire to contribute, collection of the advertisement materials can be promoted.

Further, when the reward is provided to the provider who has provided the specific game screen, the reward can further promote the provision of the specific game screen 50 as the advertisement material. In addition, since the game advertisement 60 is automatically generated, time and effort for generating the game advertisement 60 can be reduced. Meanwhile, since the game advertisement 60 is created in the format 61 according to the play situation of the game, the game advertisement 60 more suitable for the play situation is generated. Accordingly, quality of the game advertisement 60 can be ensured.

Furthermore, the method for discriminating the advertisement material includes the automatic pickup type and the player designation type. In the player designation type, an intention of the player can be reflected in the discrimination of the advertisement material (specific game screen 50). Meanwhile, in the automatic pickup type, the specific game screen 50 is automatically discriminated based on the solicitation list of the condition data CD. Therefore, more preferable advertisement materials can be collected using the condition data CD. Further, a burden on the player can be reduced.

Further, when the game advertisement 60 (game screen 50) to be distributed is partially limited through the selection criterion, the game advertisement 60 to be distributed can be more effectively limited by using the selection criterion. As a result, the advertising effect of the game advertisement 60 can be improved. Furthermore, when the selection as the distribution target is notified, it is possible to expect the provider who has provided some of the game screens 50 (the game screen 50 used for the game advertisement 60 to be distributed) to publicize the game advertisement 60 or the game through the notification of the selection. As a result, the advertising effect by the provider can also be expected.

In the above embodiment, the material collection unit 17 of the mobile game machine 3C functions as a screen discrimination unit, a data generation unit, a data transmission unit, an edit opportunity provision unit, and a permission opportunity provision unit of the present invention by executing the processing of FIG. 18 or 19. Specifically, the material collection unit 17 functions as the screen discrimination unit by executing step S102 of FIG. 18 or step S114 of FIG. 19, functions as the data generation unit by executing step S105 of FIG. 18 or FIG. 19, functions as the opportunity provision unit by executing step S106 of FIG. 18 or FIG. 19, functions as the data transmission unit by executing step S107 of FIG. 18 or FIG. 19, and functions as the permission opportunity provision unit by executing step S103 of FIG. 18 or FIG. 19. Further, the material collection unit 17 of the mobile game machine 3C functions as an advertisement information acquisition unit of the present invention by executing step S201 of FIG. 20.

Meanwhile, the advertisement generation unit 33 of the advertisement distribution system 30 functions as an information acquisition unit of the present invention by executing step S401 in FIG. 21. Further, the reward provision unit 35 of the advertisement distribution system 30 functions as an effect discrimination unit and a reward provision unit of the present invention by executing the processing of FIG. 24. Specifically, the reward provision unit 35 functions as the effect discrimination unit by executing step S801 in FIG. 24, and functions as the reward provision unit by executing step S804 in FIG. 24.

Similarly, the advertisement generation unit 33 of the advertisement distribution system 30 functions as a screen selection unit and an information notification unit of the present invention by executing the processing of FIG. 22. Specifically, the advertisement generation unit 33 functions as the screen selection unit by executing step S501 in FIG. 22, and functions as the information notification unit by executing step S508 in FIG. 22. Moreover, the advertisement generation unit 33 of the advertisement distribution system 30 functions as an advertisement generation unit of the present invention by executing step S501 in FIG. 22.

The present invention is not limited to the above-described embodiment, and may be implemented in embodiments to which various modifications or changes are applied. In addition, the present invention may be implemented in embodiments obtained by appropriately combining various technical means included in the above-described embodiments and embodiments to which the following modifications are applied and the like. For example, in the above embodiment, every time the specific game screen 50 is discriminated in the mobile game machine 3C, the display data DD for displaying the specific game screen is transmitted to the advertisement distribution system 30. However, the present invention is not limited to such an embodiment. For example, the specific game screen 50 may be stored in the mobile game machine 3C, and the stored specific game screen 50 may be provided to the advertisement distribution system 30 through a post-upload operation. In this case, a plurality of the game screens 50 may be stored as the specific game screens 50, and the game screen 50 to be transmitted may be selected by the player from among the game screens. In this case, editing may be appropriately executed in the mobile game machine 3C.

Alternatively, the storage of the plurality of game screens 50 as the specific game screens 50 may be executed in the advertisement distribution system 30. In this case, the evaluation value of each game screen 50 may be calculated before the creation of the game advertisement 60, and may be appropriately displayed at the time of editing or the like. Then, the player may select the game screen 50 to be actually provided as the material of the game advertisement 60 while referring to the evaluation values. Further, the number of game screens selectable as the material of the game advertisement 60 may be limited.

In the embodiment described above, when the plurality of game screens 50 as the specific game screens 50 is provided from one or a plurality of the mobile game machines 3C, the distribution target (the target to be used as the advertisement material of the game advertisement 60) is selected based on the selection criterion using the evaluation values. However, the present invention is not limited to such an embodiment. For example, various criteria such as the provider (whether the provider is of proven worth, or the like), the provision time (for example, the order of provision, or the like), and randomness may be applied to the selection of some of the game screens 50.

In the embodiment described above, the mobile game machine 3C (game device 3) executes the processing of FIGS. 18 to 20. As a result, the mobile game machine 3C alone functions as the game system of the present invention. However, the present invention is not limited to such an embodiment. For example, the game distribution system 20 or the advertisement distribution system 30 may execute all or some of the roles (for example, the processing in FIGS. 18 to 20) of the mobile game machine 3C. Therefore, for example, when the game distribution system 20 executes all pieces of the processing of FIGS. 18 to 20, the game distribution system 20 may function as the game system of the present invention. Alternatively, on the contrary, the game machine 3 may execute all or some of the roles of the game distribution system 20. In this case, the game distribution system 20 may be omitted.

Similarly, in the embodiment described above, the advertisement distribution system 30 executes the processing of FIGS. 21 to 24. As a result, the advertisement distribution system 30 functions as the advertisement distribution system of the present invention. However, the present invention is not limited to such an embodiment. For example, all or some of the roles of the advertisement distribution system 30 (for example, the processing in FIGS. 21 to 24) may be executed by the game distribution system 20 or the game machine 3. Therefore, for example, when the game distribution system 20 executes all pieces of the processing of FIGS. 21 to 24, the game distribution system 20 may function as the advertisement distribution system of the present invention. Alternatively, on the contrary, all or some of the roles of the game distribution system 20 may be executed by the advertisement distribution system 30. In this case, the game distribution system 20 may be omitted.

Various aspects of the present invention derived from each of the above-described embodiment and modifications will be described below. Incidentally, in the following description, to facilitate understanding of each aspect of the present invention, corresponding members illustrated in the accompanying drawings are added in parentheses, which however does not limit the present invention to the illustrated embodiment.

A game system of the present invention is a game system (3) comprising a computer (11) that is connected via a network (NT) to an advertisement distribution system (30) that distributes an advertisement to at least one advertisement display device (4) that displays the advertisement to a plurality of users, and provides each player with a game that progresses on a series of game screens (50) through an input device (TP) that inputs a play action of each player and a display device (MO) that displays the series of game screens according to a play situation generated according to the play action, wherein the computer serves as: a screen discrimination unit (17) that discriminates a specific game screen (50) that satisfies a predetermined condition among the series of game screens displayed on the display device in play by each player of the game; a data generation unit (17) that generates display data (DD) for displaying the specific game screen; and a data transmission unit (17) that transmits the display data to the advertisement distribution system such that a game advertisement (60) including the specific game screen as an advertisement material is distributed as the advertisement to the plurality of users via the advertisement display device.

According to the present invention, the specific game screen that satisfies the predetermined condition among the series of game screens according to the play situation generated according to the play action of the player is discriminated. Then, the display data for displaying the specific game screen is transmitted to the advertisement distribution system such that the game advertisement including the specific game screen is distributed as an advertisement to the advertisement display device. That is, the specific game screen generated in the play of the player is provided to the advertisement distribution system so as to be used as the advertisement material. Therefore, the specific game screen generated by the play of each player can be utilized as the advertisement material for the game advertisement. Therefore, time and effort for preparing the advertisement material can be reduced. In addition, since use of various game screens such as a latest game screen and a more attractive game screen as the advertisement materials can be promoted, the advertising effect can be improved. Furthermore, since it is possible to meet the needs of players who have a desire to contribute, collection of the advertisement materials can be promoted.

Various devices capable of displaying an advertisement may be appropriately used as the advertisement display device. For example, the user terminal device used by each user may be used or a display device installed in a public place so as to be viewed by a plurality of users may be used as the advertisement display device. Therefore, the number of advertisement display devices may be one or plural. For example, in one aspect of the game system of the present invention, when the advertisement display device includes a plurality of the advertisement display devices (4) respectively used by the plurality of users, the data transmission unit may transmit the display data to the advertisement distribution system such that the game advertisement is distributed to the plurality of users via the plurality of advertisement display devices.

Use permission of the game screen as the advertisement material may be appropriately executed, and for example, the game is provided on the premise of the use permission, the play of the game itself functions as the use permission, and an opportunity for the use permission may not be specially given. Alternatively, the opportunity for the use permission may be given at an appropriate time in the game, such as at start of playing or at the time of providing the game screen. For example, as one aspect of the game system of the present invention, an aspect wherein the computer serves as a permission opportunity provision unit (17) may be adopted, which provides a provider as a player who has provided the specific game screen as the advertisement material with a permission opportunity for permitting use of the specific game screen as the advertisement material so that distribution of the game advertisement is limited to a case where the distribution is permitted by the provider.

Further, various conditions may be appropriately used as the predetermined condition for discriminating the specific game screen. As the predetermined condition, for example, various conditions may be appropriately used, such as a condition for discriminating the specific game screen based on the play situation of the game, a condition for discriminating the specific game screen based on a lottery result, or a condition for discriminating the specific game screen based on a designation result of the player. Further, the condition required for the specific game screen may be designated in advance or may not be designated in particular. Therefore, for example, a game screen satisfying the condition designated in advance may be automatically discriminated as the specific game screen, or an arbitrary game screen based on the designation result of the player may be discriminated as the specific game screen.

Specifically, for example, in one aspect of the game system of the present invention, a designation instruction for designating the specific game screen among the series of game screens may be input to the input device, at least an instruction result by the designation instruction may be used as the predetermined condition, and the screen discrimination unit may discriminate the game screen designated by each player in the designation instruction as the specific game screen. In this case, the player's intention can be reflected in the discrimination of the advertisement material.

Further, for example, as one aspect of the game system of the present invention, an aspect wherein the computer serves as an advertisement information acquisition unit (17) which is connected via a network to a server device that stores advertisement information including information of a condition necessary for discriminating the specific game screen, and acquires the advertisement information from the server device may be adopted, and wherein the information of the condition included in the advertisement information is used as the predetermined condition, and the screen discrimination unit discriminates a game screen satisfying the condition as the specific game screen based on the information of the condition included in the advertisement information. In this case, the specific game screen is automatically discriminated based on the advertisement information. Therefore, more preferable advertisement materials can be collected using the advertisement information. Further, a burden on the player can be reduced.

The specific game screen may be directly used as the advertisement material, or may be appropriately edited and used. The same applies to the game advertisement including the specific game screen. Therefore, for example, the game advertisement may be edited by the player, or editing of the game advertisement by the player may be omitted. Specifically, for example, as one aspect of the game system of the present invention, an aspect wherein the computer serves as an edit opportunity provision unit (17) may be adopted, which provides each player with an edit opportunity for executing editing for at least one of the specific game screen or the game advertisement.

A non-transitory computer readable storage medium of the present invention is a non-transitory computer readable storage medium storing computer program (PGg) configured to cause a computer (11) connected to the advertisement distribution system, the input device, and the display device to function as each unit of the game system.

A control method according to the present invention is a control method executed by a computer (11) incorporated in a game system (3) that is connected via a network (NT) to an advertisement distribution system (30) that distributes an advertisement to at least one advertisement display device (4) that displays the advertisement to a plurality of users, and provides each player with a game that progresses on a series of game screens through an input device (TP) that inputs a play action of each player and a display device (MO) that displays the series of game screens according to a play situation generated according to the play action, wherein the control method comprises: a screen discrimination procedure of discriminating a specific game screen (50) that satisfies a predetermined condition among the series of game screens displayed on the display device in play by each player of the game; a data generation procedure of generating display data (DD) for displaying the specific game screen; and a data transmission procedure of transmitting the display data to the advertisement distribution system such that a game advertisement (60) including the specific game screen as an advertisement material is distributed as the advertisement to the plurality of users via the advertisement display device. By executing the computer program or the control method of the present invention, the game system of the present invention can be implemented.

### (Reference Example)

An advertisement distribution system according to a first reference example is an advertisement distribution system (30) that is connected via a network (NT) to at least one advertisement display device (4) that displays an advertisement to a plurality of users, and distributes a game advertisement (60) including as an advertisement material, a specific game screen (50) among a series of game screens (50) displayed on a display device (MO) according to a play situation of a game, to the advertisement display device as the advertisement, wherein the advertisement distribution system comprises: an information acquisition unit (33) that is connected via a network (NT) to a game system (3) that provides the game to each player using the display device, and acquires, from the game system, screen information including display data (MD) for displaying the specific game screen and information of a provider who has provided the specific game screen as the advertisement material in order to use the specific game screen as the advertisement material; and a reward provision unit (35) that provides the provider with a reward for providing the specific game screen based on the information of the provider.

According to the first reference example, to use the specific game screen as the advertisement material, the display data for displaying the specific game screen and the information of the provider who has provided the specific game screen as the advertisement material are acquired from the game system. Then, the game advertisement including the specific game screen as the advertisement material is distributed to the advertisement display device as the advertisement. As a result, the game screen generated by the play of each player can be utilized as the advertisement material. As a result, time and effort for preparing the advertisement material can be reduced. In addition, since use of various game screens such as a latest game screen and a more attractive game screen as the advertisement materials can be promoted, the advertising effect can be improved. Furthermore, since it is possible to meet the needs of players who have a desire to contribute, collection of the advertisement materials can be promoted. Further, the reward is provided to the provider who has provided the specific game screen as the advertisement material. Accordingly, provision of the specific game screen as the advertisement material can be further promoted.

Various elements may be appropriately used as the reward. For example, the reward may be a physical element or an electronic element. Alternatively, the reward may be an appropriate right (or qualification) such as favorable treatment of game progress or play of special development. The electronic element may include various elements such as an element usable in the game system, an element usable in a system other than the game system such as the advertisement distribution system, or an element usable in a plurality of systems such as all of the above systems. Further, the element usable in the game system may appropriately include, for example, elements (values) such as a value substituted for currency such as a consideration (in-game use may also be permitted) and a value used in the game (for example, purchase of an item, increase or addition of various parameters, or the like is included). Specifically, for example, in one aspect of the advertisement distribution system of the first reference example, the reward provision unit may provide the provider with a predetermined element permitted to be used in the game system as the reward. Further, in the aspect, the reward provision unit may provide the provider with at least one of a value functioning as a consideration when the game is played in exchange for a predetermined consideration, or a value used in the game, as the predetermined element.

When a plurality of game screens is provided as the advertisement materials, all of the game screens may be used for the game advertisements, or some of the game screens may be used for the game advertisements. Further, when all the game screens are used for the game advertisements, all the game screens may be distributed or a distribution target may be limited to some of the game screens. That is, use as the actual advertisement material may be limited to some of the game screens through the limitation of the distribution target. When the distribution target is limited to some of the game screens (including a case where the target generated as the game advertisement is limited to some of the game screens), the some of the game screens may be appropriately selected. For example, the some of the game screens may be appropriately selected according to the provider (for example, a designated provider or the like), a provision time (for example, in an early order or the like), content, a random order, a selection result by a distributor of the game advertisement, or the like. Further, when the some of the game screens is selected based on the content, the selection may be executed based on an appropriate logic. For example, each game element included in the play situation indicated by each game screen may be appropriately scored, and the selection may be executed based on a score result (evaluation value).

Specifically, for example, as one aspect of the advertisement distribution system of the first reference example, an aspect comprising a screen selection unit may be adopted, which selects some of specific game screens (50) from a plurality of the specific game screens based on a predetermined selection criterion so that the game advertisement corresponding to the some of the plurality of specific game screens is generated when the screen information corresponding to each of the plurality of specific game screens is acquired. In this case, by using the selection criterion, it is possible to limit the distribution target game advertisements to more effective some game screen. As a result, the advertising effect of the game advertisement can be improved.

When the distribution target is limited to some of the plurality of game screens, the provider who has provided the some of the game screens may or may not be notified of distribution as the game advertisement (or use as the advertisement material). For example, as an aspect of the first reference example in which the distribution target is limited to some of the game screens, an aspect comprising a information notification unit (33) may be adopted, which is connected to a user terminal device (3C) used by each provider via a network (NT) and notifies the provider who has provided the some of game screens of selection of the some of game screens via the user terminal device based on notification destination data (AD) associating information of a notification destination for notifying information via the user terminal device with the information of the provider of the each provider, when the plurality of game screens is provided by a plurality of providers. In this case, through the notification of the selection as the some of the game screens, it is possible to expect the provider who has provided the some of the game screens to publicize the game advertisement or the game. As a result, the advertising effect by the provider can also be expected.

The reward associated with the provision of the advertisement material may be fixed or variable. When a variable reward is provided, content thereof may be changed as appropriate. For example, the content may be changed according to content of the game screen, or may be changed according to the presence or absence of selection as the distribution target. Alternatively, the variable reward may be changed by the advertising effect when the game screen is distributed as the game advertisement. Further, the advertising effect may be determined as appropriate. For example, the advertising effect may be determined by a numerical value such as the number of links when the game advertisement is configured to be linked to another website or the number of purchases of products (including download of software) on the website. Alternatively, the advertising effect may be determined by the number of distributions (the number of views) as the game advertisement. Such a variable reward may be provided once after measurement of the advertising effect, or may be provided a plurality of times. When the reward is provided a plurality of times, a fixed reward may be provided at an appropriate time such as the first time. That is, the variable reward may be provided separately as the fixed reward and an additional reward based on the advertising effect. For example, as one aspect of the advertisement distribution system of the first reference example, an aspect comprising an effect discrimination unit (35) may be adapted, which discriminates the advertising effect of the game advertisement, and wherein the reward provision unit provides the provider with the reward such that the higher the advertising effect of the game advertisement, the higher the value.

Various devices capable of displaying an advertisement may be appropriately used as the advertisement display device. For example, the user terminal device used by each user may be used or a display device installed in a public place so as to be viewed by a plurality of users may be used as the advertisement display device. Therefore, the number of advertisement display devices may be one or plural. For example, in one aspect of the advertisement distribution system of the first reference example, a plurality of the advertisement display devices (4) respectively used by the plurality of users as the advertisement display devices may be connected, and the game advertisement may be distributed to the plurality of advertisement display devices.

A computer program (PG2) of the first reference example is configured to cause a computer (31) connected to the advertisement display device and the game system to function as each unit of the advertisement distribution system described above.

A control method according to the first reference example is a control method executed by a computer (31) incorporated in an advertisement distribution system (30) that is connected via a network (NT) to at least one advertisement display device (4) that displays an advertisement to a plurality of users, and distributes a game advertisement (60) including a specific game screen (50) among a series of game screens (50) displayed on a display device (MO) according to a play situation of a game as an advertisement material to the advertisement display device as the advertisement, wherein the control method comprises: an information acquisition procedure of being connected via a network (NT) to a game system (3) that provides the game to each player using the display device, and acquiring, from the game system, screen information including display data (MD) for displaying the specific game screen and information of a provider who has provided the specific game screen as the advertisement material in order to use the specific game screen as the advertisement material; and a reward provision procedure of providing the provider with a reward for providing the specific game screen based on the information of the provider. By executing the computer program or the control method according to the first reference example, the advertisement distribution system according to the first reference example can be implemented.

Meanwhile, an advertisement distribution system according to a second reference example is an advertisement distribution system (30) that is connected via a network (NT) to at least one advertisement display device (4) that displays an advertisement to a plurality of users, and distributes a game advertisement (60) including as an advertisement material, a specific game screen (50) among a series of game screens (50) displayed on a display device (MO) according to a play situation of a game, to the advertisement display device as the advertisement, wherein the advertisement distribution system comprises: an information acquisition unit (33) that is connected via a network (NT) to a game system (3) that provides each player with the game using the display device, and acquires, from the game system, screen information including display data (MD) for displaying the specific game screen and situation information indicating a play situation of the specific game screen; and an advertisement generation unit (33) that generates the game advertisement by incorporating the specific game screen into a screen portion (62 or 68) as a portion into which the specific game screen is to be incorporated, and which is included in a predetermined format (66) prepared as a fixed form of the game advertisement.

According to the second reference example, the display data for displaying the specific game screen and the situation information indicating the play situation of the specific game screen are acquired from the game system, the specific game screen is incorporated in the screen portion of the predetermined format, and the game advertisement is generated. That is, the game advertisement is automatically generated based on the specific game screen and the format for the specific game screen. Then, the game advertisement is distributed as an advertisement to the advertisement display device. As a result, the game screen generated by the play of each player can be utilized as the advertisement material. As a result, time and effort for preparing the advertisement material can be reduced. In addition, since use of various game screens such as a latest game screen and a more attractive game screen as the advertisement materials can be promoted, the advertising effect can be improved. Furthermore, since it is possible to meet the needs of players who have a desire to contribute, collection of the advertisement materials can be promoted. In addition, since the game advertisement is automatically generated, time and effort for generating the game advertisement can also be reduced.

The format may be appropriately configured. For example, the format may be configured to change according to the play situation of the game. That is, a plurality of formats according to the play situation may be prepared, and the format according to the advertisement material may be used for generation of the game advertisement. For example, in one aspect of the advertisement distribution system of the second reference example, a plurality of formats according to the play situation of the game may be prepared as the predetermined format, and the advertisement generation unit may use the format corresponding to the play situation of the specific game screen specified based on the situation information among the plurality of formats for generation of the game advertisement. In this case, since the game advertisement is created in the format corresponding to the play situation of the game, the game advertisement more suitable for the play situation is generated. Accordingly, quality of the game advertisement can be ensured.

When a plurality of game screens is provided as the advertisement materials, all of the game screens may be used for the game advertisements, or some of the game screens may be used for the game advertisements. Further, when all the game screens are used for the game advertisements, all the game screens may be distributed or a distribution target may be limited to some of the game screens. That is, use as the actual advertisement material may be limited to some of the game screens through the limitation of the distribution target. When the distribution target is limited to some of the game screens (including a case where the target generated as the game advertisement is limited to some of the game screens), the some of the game screens may be appropriately selected. For example, the some of the game screens may be appropriately selected according to the provider (for example, a designated provider or the like), a provision time (for example, in an early order or the like), content, a random order, a selection result by a distributor of the game advertisement, or the like. Further, when the some of the game screens is selected based on the content, the selection may be executed based on an appropriate logic. For example, each game element included in the play situation indicated by each game screen may be appropriately scored, and the selection may be executed based on a score result (evaluation value).

Specifically, for example, in one aspect of the advertisement distribution system of the second reference example, the information acquisition unit may acquire the screen information corresponding to each of a plurality of the specific game screens (50) from the game system, and the advertisement generation unit may generate the game advertisement corresponding to at least some of the plurality of specific game screens. Furthermore, in the aspect, an aspect comprising a screen selection unit (33) may be adopted, which selects the some of specific game screens from the plurality of specific game screens based on a predetermined selection criterion when the game advertisement corresponding to the some of the plurality of specific game screens is generated. In this case, by using the selection criterion, it is possible to limit the distribution target game advertisements to more effective some game screen. As a result, the advertising effect of the game advertisement can be improved.

When the distribution target is limited to some of the plurality of game screens, the provider who has provided the some of the game screens may or may not be notified of distribution as the game advertisement (or use as the advertisement material). For example, as an aspect of the second reference example in which the distribution target is limited to some of the game screens, an aspect comprising an information notification unit (33) may be adopted, which is connected to a user terminal device (3C) used by each provider via a network (NT) and notifies the each provider of predetermined information based on notification destination data (AD) associating the each provider with information of a notification destination for notifying information via the user terminal device when the plurality of specific game screens is provided as the advertisement materials from a plurality of providers as a plurality of players played through the plurality of game screens, and wherein the screen information further includes information of the each provider, and the information notification unit notifies the provider who has provided the some of the game screens of selection of the some of the game screens as the predetermined information based on the information of the each provider and the notification destination data. In this case, through the notification of the selection as the some of the game screens, it is possible to expect the provider who has provided the some of the game screens to publicize the game advertisement or the game. As a result, the advertising effect by the provider can also be expected.

Various devices capable of displaying an advertisement may be appropriately used as the advertisement display device. For example, the user terminal device used by each user may be used or a display device installed in a public place so as to be viewed by a plurality of users may be used as the advertisement display device. Therefore, the number of advertisement display devices may be one or plural. For example, in one aspect of the advertisement distribution system of the second reference example, a plurality of the advertisement display devices (4) respectively used by the plurality of users as the advertisement display devices may be connected and the game advertisement is distributed to the plurality of advertisement display devices.

A computer program (PG2) of the second reference example is configured to cause a computer (31) connected to the advertisement display device and the game system to function as each unit of the advertisement distribution system described above.

A control method according to the second reference example is a control method executed by a computer (31) incorporated in an advertisement distribution system (30) that is connected via a network (NT) to at least one advertisement display device (4) that displays an advertisement to a plurality of users, and distributes a game advertisement (60) including as an advertisement material, a specific game screen (50) among a series of game screens (50) displayed on a display device (MO) according to a play situation of a game, to the advertisement display device as the advertisement, wherein the control method comprise: an information acquisition procedure of being connected via a network (NT) to a game system (3) that provides each player with the game using the display device, and acquiring, from the game system, screen information including display data (MD) for displaying the specific game screen and situation information indicating a play situation of the specific game screen; and an advertisement generation procedure of generating the game advertisement by incorporating the specific game screen into a screen portion (62 or 68) as a portion into which the specific game screen is to be incorporated, and which is included in a predetermined format (61) prepared as a fixed form of the game advertisement. By executing the computer program or the control method according to the second reference example, the advertisement distribution system according to the second reference example can be implemented.

1. A game system comprising a computer that is connected via a network to an advertisement distribution system that distributes an advertisement to at least one advertisement display device that displays the advertisement to a plurality of users, and provides each player with a game that progresses on a series of game screens through an input device that inputs a play action of each player and a display device that displays the series of game screens according to a play situation generated according to the play action, wherein the computer serves as:
a screen discrimination unit that discriminates a specific game screen that satisfies a predetermined condition among the series of game screens displayed on the display device in play by each player of the game;
a data generation unit that generates display data for displaying the specific game screen; and
a data transmission unit that transmits the display data to the advertisement distribution system such that a game advertisement including the specific game screen as an advertisement material is distributed as the advertisement to the plurality of users via the advertisement display device.

2. The game system according to claim 1, wherein when the advertisement display device includes a plurality of the advertisement display devices respectively used by the plurality of users, the data transmission unit transmits the display data to the advertisement distribution system such that the game advertisement is distributed to the plurality of users via the plurality of advertisement display devices.

3. The game system according to claim 1, wherein the computer serves as a permission opportunity provision unit which provides a provider as a player who has provided the specific game screen as the advertisement material with a permission opportunity for permitting use of the specific game screen as the advertisement material so that distribution of the game advertisement is limited to a case where the distribution is permitted by the provider.

4. The game system according to claim 1, wherein a designation instruction for designating the specific game screen among the series of game screens is input to the input device,
at least an instruction result by the designation instruction is used as the predetermined condition, and
the screen discrimination unit discriminates the game screen designated by each player in the designation instruction as the specific game screen.

5. The game system according to claim 1, wherein the computer serves as an advertisement information acquisition unit which is connected via a network to a server device that stores advertisement information including information of a condition necessary for discriminating the specific game screen, and acquires the advertisement information from the server device, and wherein
the information of the condition included in the advertisement information is used as the predetermined condition, and
the screen discrimination unit discriminates a game screen satisfying the condition as the specific game screen based on the information of the condition included in the advertisement information.

6. The game system according to claim 1, wherein the computer serves as an edit opportunity provision unit which provides each player with an edit opportunity for executing editing for at least one of the specific game screen or the game advertisement.

7. A non-transitory computer readable storage medium storing a computer program which is configured to cause a computer connected to the advertisement distribution system, the input device, and the display device to function as each unit of the game system according to claim 1.

8. A control method executed by a computer incorporated in a game system that is connected via a network to an advertisement distribution system that distributes an advertisement to at least one advertisement display device that displays the advertisement to a plurality of users, and provides each player with a game that progresses on a series of game screens through an input device that inputs a play action of each player and a display device that displays the series of game screens according to a play situation generated according to the play action, wherein the control method comprises:
a screen discrimination procedure of discriminating a specific game screen that satisfies a predetermined condition among the series of game screens displayed on the display device in play by each player of the game;
a data generation procedure of generating display data for displaying the specific game screen; and
a data transmission procedure of transmitting the display data to the advertisement distribution system such that a game advertisement including the specific game screen as an advertisement material is distributed as the advertisement to the plurality of users via the advertisement display device.
